(19) United States
(12) Patent Application Publication
(10) Pub. No.: US 2026/0270888 A1
(43) Pub. Date: Sep. 10, 2026

(54) MULTI-POWER-LEVEL SIGNAL

(71) Applicant: Qualcomm Incorporated, San Diego, CA (US)

(72) Inventors: Mohamed Fouad Ahmed MARZBAN, San Diego, CA (US); Narayan PRASAD, Westfield, NJ (US); Tao LUO, San Diego, CA (US)

(21) Appl. No.: 19/468,409

(22) Filed: Feb. 3, 2026

Related U.S. Application Data
(60) Provisional application No. 63/769,503, filed on Mar. 10, 2025.

(51) Int. Cl. H04W 52/36; H04L 5/00; H04W 8/22; H04W 52/32

(52) U.S. Cl. CPC H04W 52/36; H04L 5/0053; H04W 8/22; H04W 52/325

(57) ABSTRACT

Various aspects of the present disclosure generally relate to wireless communication. In some aspects, a user equipment (UE) may receive, from a network node, a configuration of a multi-power-level signal including multiple segments associated with different transmit power levels. The UE may receive, from the network node, the multi-power-level signal in accordance with the configuration. The UE may transmit, to the network node, feedback associated with the multi-power-level signal. Numerous other aspects are described.

### CROSS-REFERENCE TO RELATED APPLICATION

This Patent Application claims priority to U.S. Provisional Patent Application No. 63/769,503, filed on Mar. 10, 2025, entitled “MULTI-POWER-LEVEL SIGNAL,” and assigned to the assignee hereof. The disclosure of the prior Application is considered part of and is incorporated by reference into this Patent Application.

### FIELD OF THE DISCLOSURE

Aspects of the present disclosure generally relate to wireless communication and specifically relate to techniques, apparatuses, and methods associated with a multi-power-level signal.

### DESCRIPTION OF THE RELATED TECHNOLOGY

Wireless communication systems are widely deployed to provide various services, which may involve carrying or supporting voice, text, other messaging, video, data, or other traffic. Typical wireless communication systems may employ multiple-access radio access technologies (RATs) capable of supporting communication among multiple wireless communication devices including user devices or other devices by sharing the available system resources (for example, time domain resources, frequency domain resources, spatial domain resources, or device transmit power, among other examples). Such multiple-access RATs are supported by technological advancements that have been adopted in various telecommunication standards, which define common protocols that enable different wireless communication devices to communicate on a local, municipal, national, regional, or global level. An example telecommunication standard is New Radio (NR). NR, which also may be referred to as 5G, is part of a continuous mobile broadband evolution promulgated by the Third Generation Partnership Project (3GPP). As the demand for connectivity continues to increase, further improvements in NR may be implemented, and other RATs, such as 6G and beyond, may be introduced to enable new applications and facilitate new use cases.

### SUMMARY

In a wireless communication network, radio frequency (RF) components at a receiving wireless communication device (e.g., a network node or a user equipment (UE)) may be associated with some impairments that degrade a link performance of a link between a transmitting wireless communication device (e.g., a UE or a network node) and the receiving wireless communication device. Current approaches for probing and mitigating receiver RF impairments rely on power control commands. For example, in closed-loop uplink power control scenarios, a UE may adjust a transmit power of uplink communications transmitted by the UE based on adjustment configurations received from a network node (e.g., via transmit power control (TPC) commands) to enhance the link performance. That is, the network node may transmit, to the UE, multiple TPC commands, and the UE may adjust the transmit power of uplink communications in accordance with the multiple TPC commands. Using power control via the TPC commands, the UE and the network node can detect the best power region of operation for the UE via probing different transmit powers, and can reduce the impact of RF impairments at the receiver on the link performance. However, such closed-loop power control approaches for probing receiver RF impairments are associated with a high signaling overhead for transmission of multiple TPC commands and a high latency for receiving multiple TPC commands and estimating the RF impairments associated with the TPC commands to identify a best power region of operation. Furthermore, such closed-loop power control approaches for probing receiver RF impairments may not be agile enough to optimally adapt to varying channel conditions.

Various aspects relate generally to a multi-power-level signal. Some aspects more specifically relate to a multi-power-level signal for probing and mitigating the impact of receiver RF impairments. In some aspects, a UE may receive, from a network node, a configuration of a multi-power-level signal that includes multiple segments associated with different power levels. The UE may transmit the multi-power-level signal to the network node in accordance with the configuration. In some aspects, a UE may receive, from a network node, a configuration of a multi-power-level signal that includes multiple segments associated with different power levels, and the UE may receive the multi-power-level signal from the network node in accordance with the configuration. In such aspects, the UE may transmit, to the network node, feedback associated with the multi-power-level signal. In some aspects, the multi-power-level signal may be used for probing and mitigating RF impairment impacts. In this way, wireless communication devices may be enabled to assess and mitigate receiver RF impairments for uplink or downlink communications with reduced latency, reduced signaling overhead, and increased adaptability to varying channel conditions.

Some aspects described herein relate to a UE. The UE may include a processing system. The processing system may include one or more processors and one or more code-storing memories coupled with the one or more processors. The processing system may be configured to cause the UE to receive, from a network node, a configuration of a multi-power-level signal including multiple segments associated with different transmit power levels. The processing system may be configured to cause the UE to receive, from the network node, the multi-power-level signal in accordance with the configuration. The processing system may be configured to cause the UE to transmit, to the network node, feedback associated with the multi-power-level signal.

Some aspects described herein relate to a network node. The network node may include a processing system. The processing system may include one or more processors and one or more code-storing memories coupled with the one or more processors. The processing system may be configured to cause the network node to transmit, to a UE, a configuration of a multi-power-level signal including multiple segments associated with different transmit power levels. The processing system may be configured to cause the network node to transmit, to the UE, the multi-power-level signal in accordance with the configuration. The processing system may be configured to cause the network node to receive, from the UE, feedback associated with the multi-power-level signal.

Some aspects described herein relate to a UE. The UE may include a processing system. The processing system may include one or more processors and one or more code-storing memories coupled with the one or more processors. The processing system may be configured to cause the UE to receive, from a network node, a configuration of a multi-power-level signal including multiple segments associated with different transmit power levels. The processing system may be configured to cause the UE to transmit, to the network node, the multi-power-level signal in accordance with the configuration.

Some aspects described herein relate to a network node. The network node may include a processing system. The processing system may include one or more processors and one or more code-storing memories coupled with the one or more processors. The processing system may be configured to cause the network node to transmit, to a UE, a configuration of a multi-power-level signal including multiple segments associated with different transmit power levels. The processing system may be configured to cause the network node to receive, from the UE, the multi-power-level signal in accordance with the configuration.

Some aspects described herein relate to a method of wireless communication performed by a UE. The method may include receiving, from a network node, a configuration of a multi-power-level signal including multiple segments associated with different transmit power levels. The method may include receiving, from the network node, the multi-power-level signal in accordance with the configuration. The method may include transmitting, to the network node, feedback associated with the multi-power-level signal.

Some aspects described herein relate to a method of wireless communication performed by a network node. The method may include transmitting, to a UE, a configuration of a multi-power-level signal including multiple segments associated with different transmit power levels. The method may include transmitting, to the UE, the multi-power-level signal in accordance with the configuration. The method may include receiving, from the UE, feedback associated with the multi-power-level signal.

Some aspects described herein relate to a method of wireless communication performed by a UE. The method may include receiving, from a network node, a configuration of a multi-power-level signal including multiple segments associated with different transmit power levels. The method may include transmitting, to the network node, the multi-power-level signal in accordance with the configuration.

Some aspects described herein relate to a method of wireless communication performed by a network node. The method may include transmitting, to a UE, a configuration of a multi-power-level signal including multiple segments associated with different transmit power levels. The method may include receiving, from the UE, the multi-power-level signal in accordance with the configuration.

Some aspects described herein relate to a non-transitory computer-readable medium that stores a set of instructions for wireless communication by a UE. The set of instructions, when executed by one or more processors of the UE, may cause the UE to receive, from a network node, a configuration of a multi-power-level signal including multiple segments associated with different transmit power levels. The set of instructions, when executed by one or more processors of the UE, may cause the UE to receive, from the network node, the multi-power-level signal in accordance with the configuration. The set of instructions, when executed by one or more processors of the UE, may cause the UE to transmit, to the network node, feedback associated with the multi-power-level signal.

Some aspects described herein relate to a non-transitory computer-readable medium that stores a set of instructions for wireless communication by a network node. The set of instructions, when executed by one or more processors of the network node, may cause the network node to transmit, to a UE, a configuration of a multi-power-level signal including multiple segments associated with different transmit power levels. The set of instructions, when executed by one or more processors of the network node, may cause the network node to transmit, to the UE, the multi-power-level signal in accordance with the configuration. The set of instructions, when executed by one or more processors of the network node, may cause the network node to receive, from the UE, feedback associated with the multi-power-level signal.

Some aspects described herein relate to a non-transitory computer-readable medium that stores a set of instructions for wireless communication by a UE. The set of instructions, when executed by one or more processors of the UE, may cause the UE to receive, from a network node, a configuration of a multi-power-level signal including multiple segments associated with different transmit power levels. The set of instructions, when executed by one or more processors of the UE, may cause the UE to transmit, to the network node, the multi-power-level signal in accordance with the configuration.

Some aspects described herein relate to a non-transitory computer-readable medium that stores a set of instructions for wireless communication by a network node. The set of instructions, when executed by one or more processors of the network node, may cause the network node to transmit, to a UE, a configuration of a multi-power-level signal including multiple segments associated with different transmit power levels. The set of instructions, when executed by one or more processors of the network node, may cause the network node to receive, from the UE, the multi-power-level signal in accordance with the configuration.

Some aspects described herein relate to an apparatus for wireless communication. The apparatus may include means for receiving, from a network node, a configuration of a multi-power-level signal including multiple segments associated with different transmit power levels. The apparatus may include means for receiving, from the network node, the multi-power-level signal in accordance with the configuration. The apparatus may include means for transmitting, to the network node, feedback associated with the multi-power-level signal.

Some aspects described herein relate to an apparatus for wireless communication. The apparatus may include means for transmitting, to a UE, a configuration of a multi-power-level signal including multiple segments associated with different transmit power levels. The apparatus may include means for transmitting, to the UE, the multi-power-level signal in accordance with the configuration. The apparatus may include means for receiving, from the UE, feedback associated with the multi-power-level signal.

Some aspects described herein relate to an apparatus for wireless communication. The apparatus may include means for receiving, from a network node, a configuration of a multi-power-level signal including multiple segments associated with different transmit power levels. The apparatus may include means for transmitting, to the network node, the multi-power-level signal in accordance with the configuration.

Some aspects described herein relate to an apparatus for wireless communication. The apparatus may include means for transmitting, to a UE, a configuration of a multi-power-level signal including multiple segments associated with different transmit power levels. The apparatus may include means for receiving, from the UE, the multi-power-level signal in accordance with the configuration.

The systems, methods, and devices of this disclosure each have several innovative aspects, no single one of which is solely responsible for the desirable attributes disclosed herein.

Aspects of the present disclosure may generally be implemented by or as a method, apparatus, system, computer program product, non-transitory computer-readable medium, user equipment, network node, wireless communication device, or processing system as substantially described in the Detailed Description with reference to, and as illustrated by, the accompanying drawings. Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 is a diagram illustrating an example of a wireless communication network.

FIG. 2 is a diagram illustrating an example disaggregated network node architecture.

FIGS. 3A-B are diagrams illustrating examples associated with an uplink multi-power-level signal.

FIG. 4 is a diagram illustrating an example associated with a downlink multi-power-level signal.

FIG. 5 is a diagram illustrating an example process performed, for example, at a user equipment (UE) or an apparatus of a UE.

FIG. 6 is a diagram illustrating an example process performed, for example, at a network node or an apparatus of a network node.

FIG. 7 is a diagram illustrating an example process performed, for example, at a UE or an apparatus of a UE.

FIG. 8 is a diagram illustrating an example process performed, for example, at a network node or an apparatus of a network node.

FIG. 9 is a diagram of an example apparatus for wireless communication.

FIG. 10 is a diagram of an example apparatus for wireless communication.

### DETAILED DESCRIPTION

In a wireless communication network, a transmitting wireless communication device (e.g., a user equipment (UE) or a network node) may transmit a radio frequency (RF) signal to a receiving wireless communication device (e.g., a network node or a UE) over a link (e.g., an uplink or a downlink) between the wireless communication devices. In some examples, RF components (e.g., analog-to-digital converters (ADCs), digital-to-analog converters (DACs), low noise amplifiers (LNAs), RF filters, phase-locked loops (PLLs), or power amplifiers (PAs), among other examples) at a receiving wireless communication device may be associated with some impairments (e.g., non-linearities, phase noise, in-phase and quadrature (I/Q) imbalance, or adjacent channel interference, among other examples) that degrade the link performance of the link between a transmitting wireless communication device and the receiving wireless communication device.

Current approaches for probing and mitigating receiver RF impairments rely on power control commands. In some examples, a UE, using open loop uplink power control, may adjust a transmit power of uplink communications transmitted by the UE based on nominal parameters and estimated pathloss. In closed-loop uplink power control scenarios, the UE may also adjust the transmit power of uplink communications transmitted by the UE based on adjustment configurations received from a network node (e.g., via transmit power control (TPC) commands) to enhance the link performance. That is, the network node may transmit, to the UE, multiple TPC commands, and the UE may adjust the transmit power of uplink communications in accordance with the multiple TPC commands. Using power control via the TPC commands, the UE and the network node can detect the best power region of operation for the UE via probing different transmit powers, and can reduce the impact of RF impairments at the receiver on the link performance. However, such closed-loop power control approaches for probing receiver RF impairments are associated with a high signaling overhead for transmission of multiple TPC commands and a high latency for receiving multiple TPC commands and estimating the RF impairments associated with the TPC commands to identify a best power region of operation. Furthermore, such closed-loop power control approaches for probing receiver RF impairments may not be agile enough to optimally adapt to varying channel conditions (e.g., due to the high latency).

Various aspects relate generally to a multi-power-level signal. Some aspects more specifically relate to a multi-power-level signal for probing and mitigating the impact of receiver RF impairments. In some aspects, a UE may receive, from a network node, a configuration of a multi-power-level signal that includes multiple segments associated with different power levels. The UE may transmit the multi-power-level signal to the network node in accordance with the configuration. The multi-power-level signal may be a reference signal, a control signal, a data signal, or a combination thereof. In some examples, the network node may receive the multi-power-level signal, and the network node may use the multi-power-level signal to probe RF components of the network node and identify a best power region for a transmit power to be used by the UE for uplink communications. In such examples, the network node may transmit, to the UE, an indication of a transmit power based on the multi-power-level signal, and the UE may transmit one or more uplink communications using the transmit power. In some aspects, a UE may receive, from a network node, a configuration of a multi- power-level signal that includes multiple segments associated with different power levels, and the UE may receive the multi-power-level signal from the network node in accordance with the configuration. In such aspects, the UE may transmit, to the network node, feedback associated with the multi-power-level signal. For example, the feedback may include values for a metric associated with an accuracy of receiving the segments of the multi-power-level signal or an indication of a recommend transmit power level to be used by the network node for downlink communications. In some examples, the network node may transmit, to the UE, one or more downlink communications using a transmit power based on the feedback associated with the multi-power-level signal.

Particular aspects of the subject matter described in this disclosure can be implemented to realize one or more of the following potential advantages. In some examples, the described techniques can be used to enable faster assessment and mitigation of receiver RF front end impairments. For example, the multi-power-level signal can be used to quickly assess power regions where the receiver front end saturates or enters a non-linear regime, to implement faster closed-loop power control (e.g., as compared with power control using multiple TPC commands), and to quickly adapt the power control to varying channel conditions. In some examples, by the UE receiving the configuration of the multi-power-level signal and transmitting the multi-power-level signal in accordance with the configuration, the described techniques can be used to decrease latency and signaling overhead associated with probing and mitigating receiver RF impairments (e.g., at the network node) for uplink communications and to increase adaptability of uplink power control to varying channel conditions. In some examples, by the UE receiving the configuration of the multi-power-level signal, receiving the multi-power-level signal from the network node in accordance with the configuration, and transmitting, to the network node, feedback associated with the multi-power-level signal, the described techniques can be used to probe and mitigate receiver RF impairments (e.g., at the UE) for downlink communications with decreased latency, decreased control signaling overhead, and increased adaptability to varying channel conditions.

5G New Radio (NR) may support enhanced mobile broadband (eMBB) access, Internet of Things (IoT) networks or reduced capability (RedCap) device deployments, ultra-reliable low-latency communication (URLLC) applications, or massive machine-type communication (mMTC), among other examples. To support these and other target verticals, a wireless communication system may be designed to implement a modularized functional infrastructure, a disaggregated and service-based network architecture, network function virtualization, network slicing, multi-access edge computing, millimeter wave (mmWave) technologies including massive multiple-input multiple-output (MIMO), beamforming, IoT device or RedCap device connectivity and management, industrial connectivity, licensed and unlicensed spectrum access, sidelink and other device-to-device direct communication (for example, cellular vehicle-to-everything (CV2X) communication), frequency spectrum expansion, overlapping spectrum use, small cell deployments, non-terrestrial network (NTN) deployments, device aggregation, advanced duplex communication (for example, sub-band full-duplex (SBFD)), multiple-subscriber implementations, high-precision positioning, RF sensing, network energy savings (NES), low-power signaling and radios, or artificial intelligence or machine learning (AI/ML), among other examples.

The foregoing and other technological improvements may support use cases, such as wireless fronthauls, wireless midhauls, wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial or aerial platforms, among other examples.

The methods, operations, apparatuses, and techniques described herein may enable one or more of the foregoing technologies or new technologies or support one or more of the foregoing use cases or new use cases.

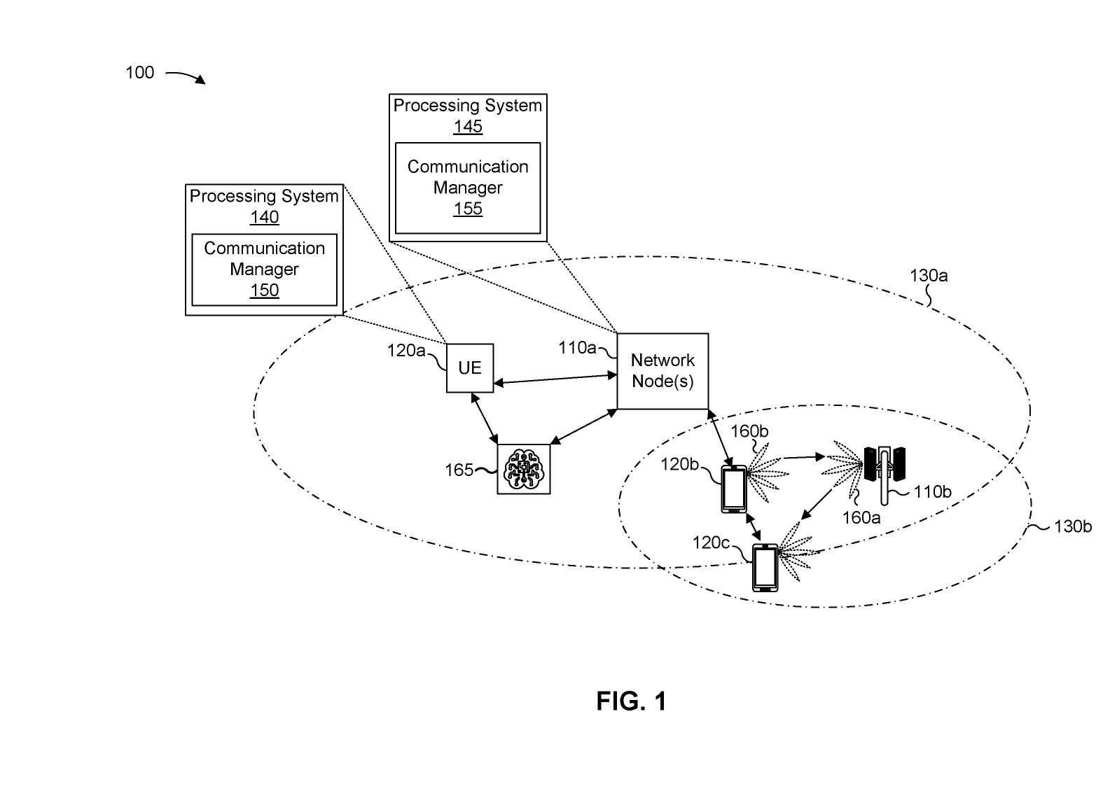

FIG. 1 is a diagram illustrating an example of a wireless communication network 100. The wireless communication network 100 may be or may include elements of a 5G network or a 6G network, among other examples. The wireless communication network 100 may include multiple network nodes 110. For example, in FIG. 1, the wireless communication network 100 includes multiple network nodes 110, including a network node 110a and a network node 110b (each of which also may be referred to herein simply as a “network node 110”). The network nodes 110 may support communications with multiple UEs 120. For example, in FIG. 1, the network nodes 110 support communication with a UE 120a, a UE 120b, and a UE 120c (each of which also may be referred to herein simply as a “UE 120”). In some examples, a UE 120 also may communicate with other UEs 120 and a network node 110 also may communicate with a core network and with other network nodes 110.

The network nodes 110 and the UEs 120 of the wireless communication network 100 communicate using the electromagnetic spectrum, which may be subdivided into various licensed or unlicensed operating bands, frequency ranges, component carriers, or channels that define associated frequencies available for communications. In some examples, each of the network nodes 110 and the UEs 120 may communicate using one or multiple component carriers in one or more operating bands or ranges. Typically, various operating bands are defined as frequency range designations FR1 (410 MHz through 7.125 GHz), FR2 (24.25 GHz through 52.6 GHz), FR3 (7.125 GHz through 24.25 GHz), FR4a or FR4-1 (52.6 GHz through 71 GHz), FR4 (52.6 GHz through 114.25 GHz), and FR5 (114.25 GHz through 300 GHz). Although a portion of FR1 is greater than 6 GHz, FR1 is often referred to (interchangeably) as a “sub-6 GHz” band in some documents and articles. Similarly, FR2 is often referred to (interchangeably) as a “millimeter wave” band in some documents and articles.

A network node 110 or a UE 120 may include one or more devices, components, or systems that enable communication with other devices, components, or systems of the wireless communication network 100. For example, a UE 120 and a network node 110 may each include one or more chips, system-on-chips (SoCs), chipsets, packages, or devices that individually or collectively constitute or comprise a processing system. As shown in FIG. 1, each UE 120 includes a processing system 140 and each network node 110 includes a processing system 145. A processing system (for example, the processing system 140 or the processing system 145) includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASICs), programmable logic devices (PLDs), or other discrete gate or transistor logic or circuitry (any one or more of which may be generally referred to herein individually as a “processor” or collectively as “the processor” or “the processor circuitry”). Such processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set. In some other examples, each of a group of processors may be configurable or configured to perform a same set of functions.

The processing system 140 and the processing system 145 may each include memory circuitry in the form of one or multiple memory devices, memory blocks, memory elements, or other discrete gate or transistor logic or circuitry, each of which may include or implement tangible storage media, such as random-access memory, or read-only memory, or combinations thereof (any one or more of which may be generally referred to herein individually as a “memory” or collectively as “the memory” or “the memory circuitry”). One or more of the memories may be coupled (for example, operatively coupled, communicatively coupled, electronically coupled, or electrically coupled) with one or more of the processors. One or more of the memories may individually or collectively store processor-executable code or instructions (such as software) (for example, which may be referred to as “one or more code-storing memories” or “code-storing memory circuitry”). For example, “code-storing memory” or “code-storing memory circuitry” refers to memory (or memory circuitry) that is configured to store processor-executable code or instructions. The processor-executable code or instructions, when executed by one or more of the processors, may configure one or more of the processors (or processing circuitry) to perform various functions or operations described herein. Additionally, or alternatively, in some examples, one or more of the processors may be configured to perform various functions or operations described herein without requiring configuration by software. Software shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise.

The processing system 140 and the processing system 145 may each include or be coupled with one or more modems (such as a cellular (for example, a 5G or 6G compliant) modem). In some examples, one or more processors of the processing system 140 or the processing system 145 may include or implement one or more of the modems. The processing system 140 and the processing system 145 also may include or be coupled with multiple radios (collectively “the radio”), multiple RF chains, or multiple transceivers, each of which may in turn be coupled with one or more of multiple antennas. In some examples, one or more processors of the processing system 140 or the processing system 145 may include or implement one or more of the radios, RF chains, or transceivers. An RF chain may include one or more filters, mixers, oscillators, amplifiers, ADCs, or other devices that convert between an analog signal (such as for transmission or reception via an air interface) and a digital signal (such as for processing by the processing system 140 or by the processing system 145).

A network node 110 and a UE 120 may each include one or multiple antennas or antenna arrays. Typical network nodes 110 and UEs 120 may include multiple antennas, which may be organized or structured into one or more antenna panels, one or more antenna groups, one or more sets of antenna elements, or one or more antenna arrays, among other examples. As used herein, the term “antenna” can refer to one or more antennas, one or more antenna panels, one or more antenna groups, one or more sets of antenna elements, or one or more antenna arrays. The term “antenna panel” can refer to a group of antennas (such as antenna elements) arranged in an array or panel, which may facilitate beamforming by manipulating parameters associated with the group of antennas. The term “antenna module” may refer to circuitry including one or more antennas as well as one or more other components (such as filters, amplifiers, or processors) associated with integrating the antenna module into a wireless communication device, such as the network node 110 and the UE 120.

A network node 110 may be, may include, or also may be referred to as an NR network node, a 5G network node, a 6G network node, a Node B, a gNB, an access point (AP), a transmission reception point (TRP), a network entity, a network element, a network equipment, or another type of device, component, or system included in a radio access network (RAN). In various deployments, a network node 110 may be implemented as a single physical node (for example, a single physical structure) or may be implemented as two or more physical nodes (for example, two or more distinct physical structures). For example, a network node 110 may be a device or system that implements a part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node having an aggregated architecture, meaning that the network node 110 may implement a full radio protocol stack that is physically and logically integrated within a single physical structure in the wireless communication network 100. For example, an aggregated network node 110 may include a single standalone base station or a single TRP that operates with a full radio protocol stack to enable or facilitate communication between a UE 120 and a core network of the wireless communication network 100.

Alternatively, and as also shown, a network node 110 may be a disaggregated network node 110 (sometimes referred to as a disaggregated base station), having a disaggregated architecture, meaning that the network node 110 may operate with a radio protocol stack that is physically distributed or logically distributed among two or more nodes in the same geographic location or in different geographic locations. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating network functionality into multiple units or modules that can be individually deployed.

The disaggregated network nodes 110 of the wireless communication network 100 may include one or more central units (CUs), one or more distributed units (DUs), and one or more radio units (RUs). A CU may host one or more higher layers, such as a radio resource control (RRC) layer, a packet data convergence protocol (PDCP) layer, and a service data adaptation protocol (SDAP) layer, among other examples. A DU may host one or more of a radio link control (RLC) layer, a medium access control (MAC) layer, or one or more higher physical (PHY) layers depending, at least in part, on a functional split, such as a functional split defined by the 3GPP. In some examples, a DU also may host a lower PHY layer that is configured to perform functions, such as a fast Fourier transform (FFT), an inverse FFT (IFFT), beamforming, or physical random access channel (PRACH) extraction and filtering, among other examples. An RU may perform RF processing functions or lower PHY layer functions, such as an FFT, an IFFT, beamforming, or PRACH extraction and filtering, among other examples, according to a functional split, such as a lower layer split (LLS). In such an architecture, each RU can be operated to handle over the air (OTA) communication with one or more UEs 120. In some examples, a single network node 110 may include a combination of one or more CUs, one or more DUs, or one or more RUs. In some examples, a CU, a DU, or an RU may be implemented as a virtual unit, such as a virtual central unit (VCU), a virtual distributed unit (VDU), or a virtual radio unit (VRU), among other examples, which may be implemented as a virtual network function, such as in a cloud deployment.

In some examples, the wireless communication network 100 may be a heterogeneous network that includes network nodes 110 of various types. Different types of network nodes 110 may generally operate on the same or different operating bands, transmit at different power levels, or serve different coverage areas, each of which may be referred to as or associated with a particular cell 130 (for example, a cell 130a and a cell 130b).

The UEs 120 may be physically dispersed throughout the coverage area of the wireless communication network 100, and each UE 120 may be stationary or mobile. A UE 120 may be, may include, or also may be referred to as an access terminal, a mobile station, a client device, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a netbook, a smartbook, an ultrabook, a medical device, a biometric device, a wearable device (for example, a smart watch, smart clothing, smart glasses, a smart wristband, or smart jewelry), a gaming device, an entertainment device (for example, a music device, a video device, or a satellite radio), an XR device, a vehicular component or sensor, a smart meter or sensor, industrial manufacturing equipment, a Global Navigation Satellite System (GNSS) device (such as a Global Positioning System device or another type of positioning device), an artificially intelligent robot or other device implementing artificial intelligence, a UE function of a network node, or any other suitable device or function that may communicate in the wireless communication network 100.

Some UEs 120 may be classified according to different categories in association with different complexities or different capabilities. UEs 120 in a first category may be associated with relatively low complexity or cost such as NB-IoT devices or eMTC UEs. UEs 120 in a second category may include higher complexity or cost devices, such as mission-critical IoT devices, baseline UEs, high-tier UEs, advanced UEs, full-capability UEs, or premium UEs that are capable of URLLC, eMBB, or precise positioning in the wireless communication network 100. A third category of UEs 120 may have mid-tier complexity or capabilities (for example, capabilities between that of the UEs 120 of the first category and the UEs 120 of the second category). A UE 120 of the third category may be referred to as a reduced capability UE (“RedCap UE”), a mid-tier UE, an NR-Light UE, or an NR-Lite UE, among other examples.

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink and uplink resources may include time domain resources (for example, frames, subframes, slots, and symbols), frequency domain resources (for example, frequency bands, component carriers (CCs), subcarriers, resource blocks, and resource elements), and spatial domain resources (for example, particular transmit directions or beams).

Frequency domain resources may be subdivided into bandwidth parts (BWPs). A BWP may be a block of frequency domain resources (for example, a continuous set of resource blocks (RBs) within a full component carrier bandwidth) that may be configured at a UE-specific level. A UE 120 may be configured with both an uplink BWP and a downlink BWP (which may be the same or different). Each BWP may be associated with its own numerology (indicating a sub-carrier spacing (SCS) and cyclic prefix (CP)). A BWP may be dynamically configured or activated (for example, by a network node 110 transmitting a downlink control information (DCI) configuration to the one or more UEs 120) or reconfigured (for example, in real-time or near-real-time) according to changing network conditions in the wireless communication network 100 or specific requirements of one or more UEs 120. An active BWP defines the operating bandwidth of the UE 120 within the operating bandwidth of the serving cell.

As used herein, a downlink signal may be or include a reference signal, control information, or data. For example, downlink reference signals include a primary synchronization signal (PSS), a secondary SS (SSS), an SS block (SSB) (for example, that includes a PSS, an SSS, and a physical broadcast channel (PBCH)), a demodulation reference signal (DMRS), a phase tracking reference signal (PTRS), a tracking reference signal (TRS), and a channel state information (CSI) reference signal (CSI-RS), among other examples. A downlink signal carrying control information or data may be transmitted via a downlink channel. Downlink channels may include one or more control channels for transmitting control information and one or more data channels for transmitting data. Downlink reference signals may be transmitted in addition to, or multiplexed with, downlink control channel communications or downlink data channel communications. A downlink control channel may be specifically used to transmit DCI from a network node 110 to a UE 120. DCI generally contains the information the UE 120 needs to identify RBs in a subsequent subframe and how to decode them, including a modulation and coding scheme (MCS) or redundancy version parameters. Different DCI formats carry different information, such as scheduling information in the form of downlink or uplink grants, slot format indicators (SFIs), preemption indicators (PIs), TPC commands, hybrid automatic repeat request (HARQ) information, new data indicators (NDIs), among other examples. A downlink data channel may be used to transmit downlink data (for example, user data associated with a UE 120) from a network node 110 to a UE 120. Downlink control channels may include physical downlink control channels (PDCCHs), and downlink data channels may include physical downlink shared channels (PDSCHs). Control information or data communications may be transmitted on a PDCCH and PDSCH, respectively. For example, a PDCCH can carry DCI, while a PDSCH can carry a MAC control element (MAC-CE), an RRC message, or user data, among other examples. Each PDSCH may carry one or more transport blocks (TBs) of data.

As used herein, an uplink signal may include a reference signal, control information, or data. For example, uplink reference signals include a sounding reference signal (SRS), a PTRS, and a DMRS, among other examples. An uplink signal carrying control information or data may be transmitted via an uplink channel. An uplink channel may include one or more control channels for transmitting control information and one or more data channels for transmitting data. Uplink reference signals may be transmitted in addition to, or multiplexed with, uplink control channel communications or uplink data channel communications. An uplink control channel may be specifically used to transmit uplink control information (UCI) from a UE 120 to a network node 110. An uplink data channel may be used to transmit uplink data (for example, user data associated with a UE 120) from a UE 120 to a network node 110. Uplink control channels may include physical uplink control channels (PUCCHs), and uplink data channels may include physical uplink shared channels (PUSCHs). Control information or data communications may be transmitted on a PUCCH and PUSCH, respectively. For example, a PUCCH can carry UCI, while a PUSCH can carry a MAC-CE, an RRC message, or user data, among other examples. UCI can include a scheduling request (SR), HARQ feedback information (for example, a HARQ acknowledgement (ACK) indication or a HARQ negative acknowledgement (NACK) indication), uplink power control information (for example, an uplink TPC parameter), or CSI, among other examples. CSI can include a channel quality indicator (CQI) (indicative of downlink channel conditions to facilitate selection of transmission parameters, such as an MCS, by a network node 110), a precoding matrix indicator (PMI), a CSI-RS resource indicator (CRI) (for example, indicative of a beam used to transmit a CSI-RS), an SS/PBCH resource block indicator (SSBRI) (for example, indicative of a beam used to transmit an SSB), a layer indicator (LI), a rank indicator (RI), or measurement information (for example, a layer 1 (L1)- reference signal received power (RSRP) parameter, a received signal strength indicator (RSSI) parameter, a reference signal received quality (RSRQ) parameter, among other examples) which can be used for beam management, among other examples. Each PUSCH may carry one or more TBs of data.

The information (for example, data, control information, or reference signal information) transmitted by a network node 110 to a UE 120, or vice versa, may be represented as a sequence of binary bits that are mapped (for example, modulated) to an analog signal waveform (for example, a discrete Fourier transform (DFT)-spread-orthogonal frequency division multiplexing (OFDM) (DFT-s-OFDM) waveform or a CP-OFDM waveform) that is transmitted by the network node 110 or UE 120 over a wireless communication channel. In some examples, the network node 110 or the UE 120 (for example, using the processing system 145 or the processing system 140, respectively) may select an MCS (for example, an order of quadrature amplitude modulation (QAM), such as 64-QAM, 128-QAM, or 256-QAM, among other examples) for a downlink signal or an uplink signal. For example, the network node 110 may select an MCS for a downlink signal in accordance with UCI received from the UE 120 or may transmit, to the UE 120, an indication of an MCS to be applied for an uplink signal.

A network node 110 or a UE 120 (such as by using the processing system 145 or the processing system 140, respectively, or one or more coupled modems) may perform signal processing on the information (such as filtering, amplification, modulation, digital-to-analog conversion, an IFFT operation, multiplexing, interleaving, mapping, or encoding, among other examples) to generate a processed signal in accordance with the selected MCS. In some examples, the network node 110 or the UE 120 (for example, using the processing system 145 or the processing system 140, respectively, or one or more coupled encoders or modems) may perform a channel coding operation or a forward error correction (FEC) operation to control errors in transmitted information. For example, the network node 110 or the UE 120 may perform an encoding operation to generate encoded information (such as by selectively introducing redundancy into the information, typically using an error correction code (ECC), such as a polar code or a low-density parity-check (LDPC) code). The network node 110 or the UE 120 (for example, using the processing system 145 or one or more modems) may further perform spatial processing (for example, precoding) on the encoded information to generate one or more processed or precoded signals for downlink or uplink transmission, respectively. In some examples, the network node 110a or the UE 120a may perform codebook-based precoding or non-codebook-based precoding. Codebook-based precoding may involve selecting a precoder (for example, a precoding matrix) using a codebook. For example, the network node 110a may provide precoding information indicating which precoder, defined by the codebook, is to be used by the UE 120a. Non-codebook-based precoding may involve selecting or deriving a precoder based on, or otherwise associated with, one or more downlink or uplink signal measurements. The network node 110a or the UE 120a may transmit the processed downlink or uplink signals, respectively, via one or more antennas.

The network node 110a or the UE 120a may receive uplink signals or downlink signals, respectively, via one or more antennas. The network node 110a or the UE 120a (for example, using the processing system 145 or the processing system 140, respectively, or one or more coupled modems) may perform signal processing (for example, in accordance with the MCS) on the received uplink or downlink signals, respectively (such as filtering, amplification, demodulation, analog-to-digital conversion, an FFT operation, demultiplexing, deinterleaving, de-mapping, equalization, interference cancellation, or decoding, among other examples), to map the received signal(s) to a sequence of binary bits (for example, received information) that estimates the information transmitted by the network node 110 or the UE 120 via the downlink or uplink signals. The network node 110a or the UE 120a (for example, using the processing system 145 or the processing system 140, respectively, or a coupled decoder or one or more modems) may decode the received information (such as by using an ECC, a decoding operation, or an FEC operation) to detect errors or correct bit errors in the received information to generate decoded information. The decoded information may estimate the information transmitted via the downlink or uplink signals.

In some examples, a UE 120 and a network node 110 may perform MIMO communication. MIMO communication generally refers to transmitting or receiving multiple signals (such as multiple layers or multiple data streams) simultaneously over the same time and frequency resources. A network node 110 or a UE 120 may communicate using single-user MIMO or multi-user MIMO (MU-MIMO), the latter of which being used by a network node 110 to simultaneously transmit signals to multiple UEs 120. MIMO techniques may involve spatial multiplexing (multi-layer transmission) or beamforming. To implement beamforming, the amplitudes or phases of signals transmitted via antenna elements may be modulated and shifted relative to each other (such as by manipulating a phase shift, a phase offset, or an amplitude) to generate one or more beams. For example, a network node 110 may generate one or more beams 160a, and a UE 120 may generate one or more beams 160b. The term “beam” may refer to a directional transmission of a wireless signal toward a receiving device or otherwise in a desired direction, a directional reception of a wireless signal from a transmitting device or otherwise in a desired direction, a direction associated with such a directional transmission or directional reception, a set of directional resources associated with a signal transmission or signal reception (for example, an angle of arrival, a horizontal direction, or a vertical direction), or a set of parameters or resources associated with one or more aspects of a directional signal, among other examples.

In some examples, a network node 110 or a UE 120 may implement massive MIMO, which may be associated with an increased (for example, “massive”) quantity of antennas at the network node 110 or at the UE 120, such as in a network implementing mmWave technology, which enables more precise beamforming or reduced interference. In some examples, the wireless communication network 100 may implement multi-TRP (mTRP) operation (including redundant transmission or reception on multiple TRPs) or non-coherent joint transmission (NC-JT).

The network node 110 and the UE 120 may establish a communication link or beam pair, and otherwise increase reliability, throughput, signal strength, or other signal properties for MIMO communications, by performing beam management operations, such as an initial beam acquisition operation, a beam refinement operation, or a beam recovery operation. For example, an initial beam acquisition operation may involve the network node 110 transmitting signals (for example, SSBs or other signals) via respective beams (for example, of the beams 160 of the network node 110) and the UE 120 receiving and measuring the signal(s) via respective beams of multiple beams (for example, from the beams 160 of the UE 120) to identify a best beam (or beam pair) for communication between the UE 120 and the network node 110. A beam refinement operation may involve a first device (for example, the UE 120 or the network node 110) transmitting signal(s) via a subset of beams (for example, identified based on, or otherwise associated with, measurements reported as part of one or more other beam management operations). A second device (for example, the network node 110 or the UE 120) may receive the signal(s) via a single beam (for example, to identify the best beam for communication from the subset of beams). The beam(s) may be identified or defined via one or more spatial parameters, such as a transmission configuration indicator (TCI) state or a quasi co-location (QCL) parameter, among other examples.

Some aspects and techniques as described herein may be implemented, at least in part, using an artificial intelligence (AI) program (for example, referred to herein as an “AI/ML model”), such as a program that includes a machine learning (ML) model or an artificial neural network (ANN) model. The AI/ML model may be deployed at one or more devices 165 (for example, one or more network nodes 110, one or more UEs 120, one or more servers, or one or more components of a cloud computing network, among other examples). For example, in a deployment in which AI/ML functionality is performed independently at a device 165, sometimes referred to as “overlay AI/ML,” the AI/ML model (or an instance or portion of the AI/ML model) may be deployed at a UE 120 (for example, by the processing system 140), a network node 110 (for example, by the processing system 145), one or more servers, or one or more components of a cloud computing network, among other examples. Additionally, or alternatively, in a deployment where AI/ML functionality is coordinated between different devices 165, sometimes referred to as “coordinated AI/ML,” or performed at all device and network layers, sometimes referred to as “native AI/ML,” the AI/ML model (or an instance of the AI/ML model) may be deployed at multiple devices 165 (for example, a first portion of the AI/ML model may be deployed at a UE 120 and a second portion of the AI/ML model may be deployed at a network node 110). In other examples of coordinated AI/ML or native AI/ML, a first AI/ML model may be deployed at a UE 120 and a second AI/ML model may be deployed at a network node 110. The AI/ML model(s) may be configured to enhance various aspects of the wireless communication network 100 (for example, to increase privacy, reliability, or efficient use of network bandwidth, or to reduce latency, among other examples). For example, the AI/ML model(s) may be trained to identify patterns or relationships in data corresponding to the wireless communication network 100, a device, or an air interface, among other examples. The AI/ML model(s) may support operational decisions relating to one or more aspects associated with wireless communications devices, networks, or services.

Accordingly, in some examples, the AI/ML model(s) may enable AI-as-a-Service (for example, an end-to-end AI/ML service via a user plane) for use cases, such as a self-organizing network (SON), minimization of drive test (MDT), quality of experience (QoE), positioning, sensing, predictive mobility, or traffic prediction, among other examples. In some examples, AI-as-a-Service use cases may include measurement collection reporting by a UE 120, device selection criteria (for example, according to a geographical area where measurements are to be collected or UE capabilities to be used to collected measurements), or reporting configurations (for example, reporting parameters such as location, time, or sensor information, among other examples). Additionally, or alternatively, the AI/ML model(s) may enable AI/ML procedures (for example, RAN-triggered service establishment, configuration, inferencing using UE-side or network-side models, performance monitoring or management, or capability signaling, among other examples). Additionally, or alternatively, the AI/ML model(s) may enable RAN-based AI/ML services via one or more application program interfaces (APIs) or management interfaces for use cases, such as beam management, radio resource monitoring (RRM) relaxation, mobility prediction, load prediction, network energy savings, or coverage and capacity improvements, among other examples.

In some aspects, the UE 120 may include a communication manager 150. As described in more detail elsewhere herein, the communication manager 150 may receive, from a network node, a configuration of a multi-power-level signal including multiple segments associated with different transmit power levels; and transmit, to the network node, the multi-power-level signal in accordance with the configuration.

Additionally, or alternatively, as described in more detail elsewhere herein, the communication manager 150 may receive, from a network node, a configuration of a multi-power-level signal including multiple segments associated with different transmit power levels; receive, from the network node, the multi-power-level signal in accordance with the configuration; and transmit, to the network node, feedback associated with the multi-power-level signal. Additionally, or alternatively, the communication manager 150 may perform one or more other operations described herein.

In some aspects, the network node 110 may include a communication manager 155. As described in more detail elsewhere herein, the communication manager 155 may transmit, to a UE, a configuration of a multi-power-level signal including multiple segments associated with different transmit power levels; and receive, from the UE, the multi-power-level signal in accordance with the configuration.

Additionally, or alternatively, as described in more detail elsewhere herein, the communication manager 155 may transmit, to a UE, a configuration of a multi-power-level signal including multiple segments associated with different transmit power levels; transmit, to the UE, the multi-power-level signal in accordance with the configuration; and receive, from the UE, feedback associated with the multi-power-level signal. Additionally, or alternatively, the communication manager 155 may perform one or more other operations described herein.

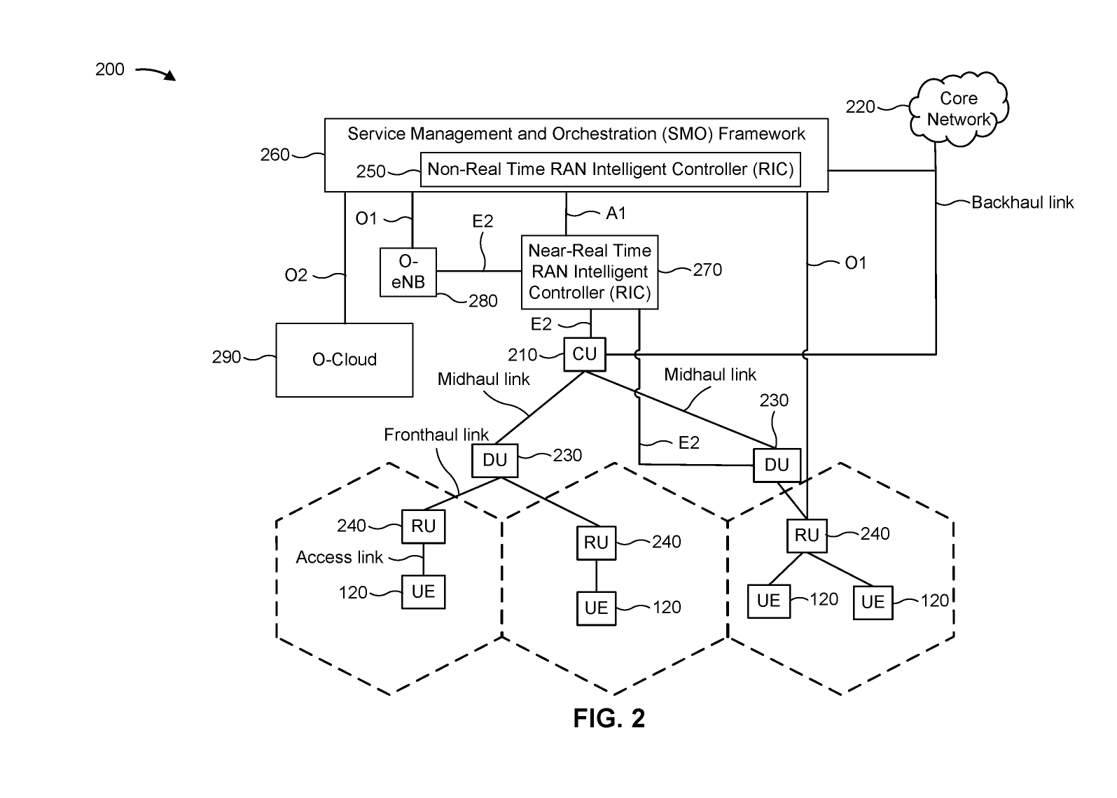

FIG. 2 is a diagram illustrating an example disaggregated network node architecture 200. One or more components of the example disaggregated network node architecture 200 may be, may include, or may be included in one or more network nodes (such one or more network nodes 110). The disaggregated network node architecture 200 may include a CU 210 that can communicate directly with a core network 220 via a backhaul link, or that can communicate indirectly with the core network 220 via one or more disaggregated control units, such as a non-real-time (Non-RT) RAN intelligent controller (RIC) 250 associated with a Service Management and Orchestration (SMO) Framework 260 or a near-real-time (Near-RT) RIC 270 (for example, via an E2 link). The CU 210 may communicate with one or more DUs 230 via respective midhaul links, such as via F1 interfaces. Each of the DUs 230 may communicate with one or more RUs 240 via respective fronthaul links. Each of the RUs 240 may communicate with one or more UEs 120 via respective RF access links. In some deployments, a UE 120 may be simultaneously served by multiple RUs 240.

Each of the components of the disaggregated network node architecture 200, including the CUs 210, the DUs 230, the RUs 240, the Near-RT RICs 270, the Non-RT RICs 250, and the SMO Framework 260, may include one or more interfaces or may be coupled with one or more interfaces for transmitting or receiving signals, such as data, control information, or reference signals via a wired or wireless transmission medium.

In some aspects, the CU 210 may be logically split into one or more CU user plane (CU-UP) units and one or more CU control plane (CU-CP) units. A CU-UP unit may communicate bidirectionally with a CU-CP unit via an interface, such as the E1 interface when implemented in an O-RAN configuration. The CU 210 may be deployed to communicate with one or more DUs 230, as necessary, for network control and signaling. Each DU 230 may correspond to a logical unit that includes one or more base station functions to control the operation of one or more RUs 240. For example, a DU 230 may host various layers, such as an RLC layer, a MAC layer, or one or more PHY layers, such as one or more high PHY layers or one or more low PHY layers. Each layer (which also may be referred to as a module) may be implemented with an interface for communicating signals with other layers (and modules) hosted by the DU 230, or for communicating signals with the control functions hosted by the CU 210. Each RU 240 may implement lower layer functionality. In some aspects, real-time and non-real-time aspects of control and user plane communication with the RU(s) 240 may be controlled by the corresponding DU 230.

The SMO Framework 260 may support RAN deployment and provisioning of non-virtualized and virtualized network elements. For non-virtualized network elements, the SMO Framework 260 may support the deployment of dedicated physical resources for RAN coverage requirements, which may be managed via an operations and maintenance interface, such as an O1 interface. For virtualized network elements, the SMO Framework 260 may interact with a cloud computing platform (such as an open cloud (O-Cloud) platform 290) to perform network element life cycle management (such as to instantiate virtualized network elements) via a cloud computing platform interface, such as an O2 interface. A virtualized network element may include, but is not limited to, a CU 210, a DU 230, an RU 240, a non-RT RIC 250, or a Near-RT RIC 270. In some aspects, the SMO Framework 260 may communicate with a hardware aspect of a 4G RAN, a 5G NR RAN, or a 6G RAN, such as an open eNB (O-eNB) 280, via an O1 interface. Additionally, or alternatively, the SMO Framework 260 may communicate directly with each of one or more RUs 240 via a respective O1 interface. In some deployments, this configuration can enable each DU 230 and the CU 210 to be implemented in a cloud-based RAN architecture, such as a vRAN architecture.

The Non-RT RIC 250 may include or may implement a logical function that enables non-real-time control and optimization of RAN elements and resources, AI/ML workflows including model training and updates, or policy-based guidance of applications or features in the Near-RT RIC 270. The Non-RT RIC 250 may be coupled to or may communicate with (such as via an A1 interface) the Near-RT RIC 270. The Near-RT RIC 270 may include or may implement a logical function that enables near-real-time control and optimization of RAN elements and resources via data collection and actions via an interface (such as via an E2 interface) connecting one or more CUs 210, one or more DUs 230, or an O-eNB 280 with the Near-RT RIC 270.

In some aspects, to generate AI/ML models to be deployed in the Near-RT RIC 270, the Non-RT RIC 250 may receive parameters or external enrichment information from external servers. Such information may be utilized by the Near-RT RIC 270 and may be received at the SMO Framework 260 or the Non-RT RIC 250 from non-network data sources or from network functions. In some examples, the Non-RT RIC 250 or the Near-RT RIC 270 may tune RAN behavior or performance. For example, the Non-RT RIC 250 may monitor long-term trends and patterns for performance and may employ AI/ML models to perform corrective actions via the SMO Framework 260 (such as reconfiguration via an O1 interface) or via creation of RAN management policies (such as A1 interface policies).

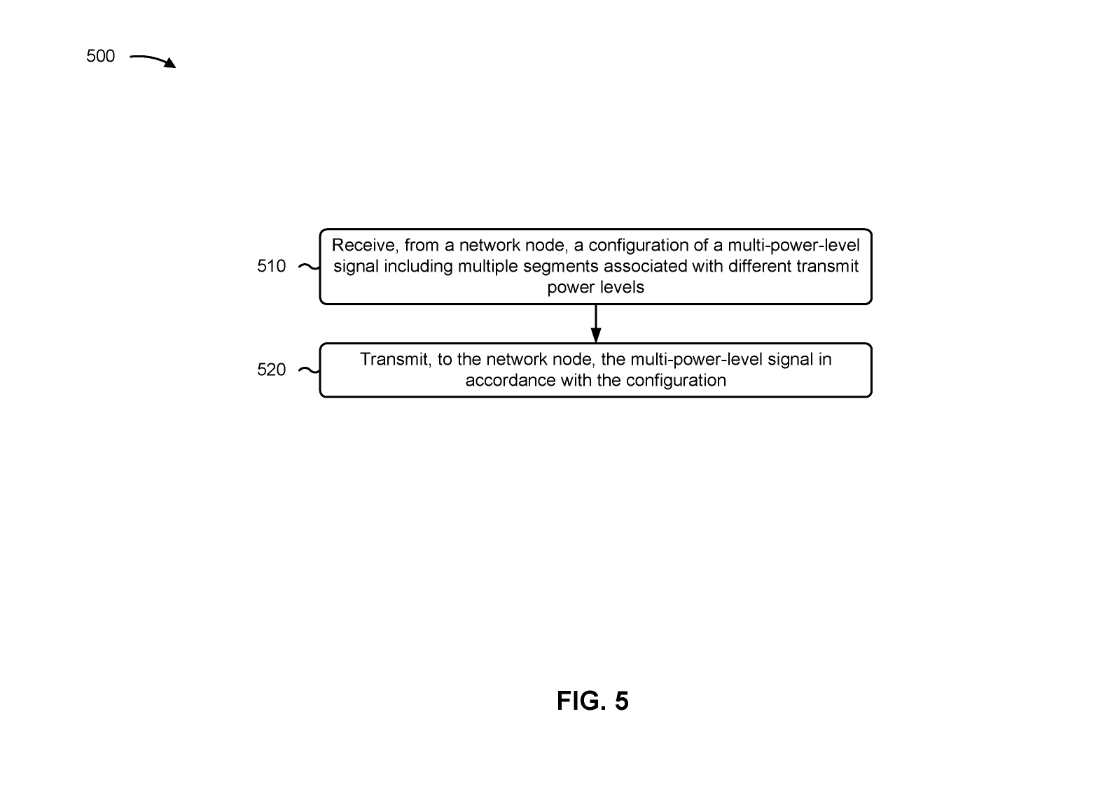

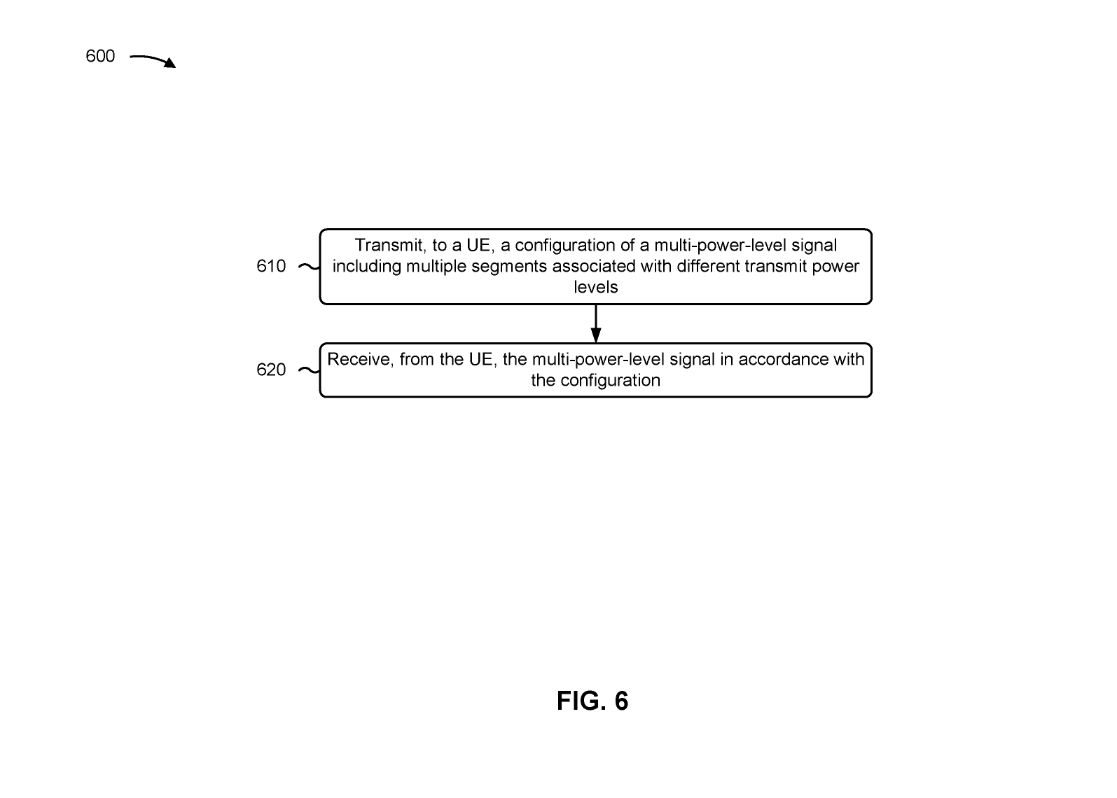

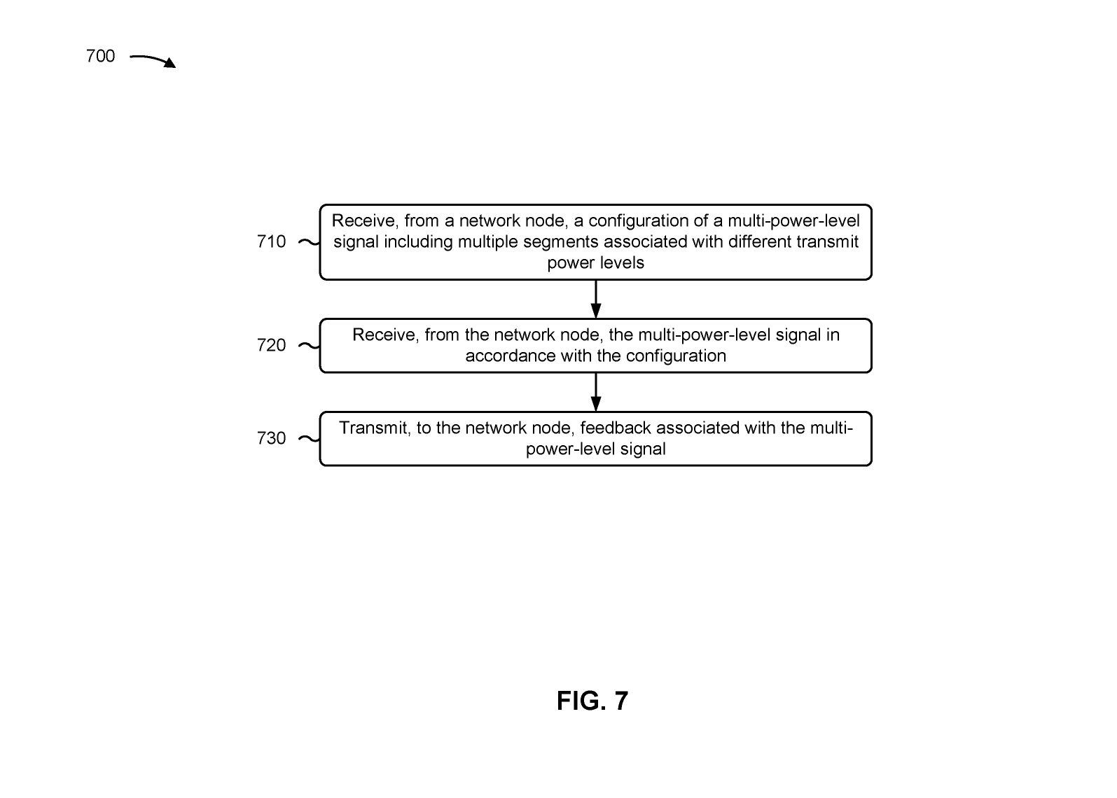

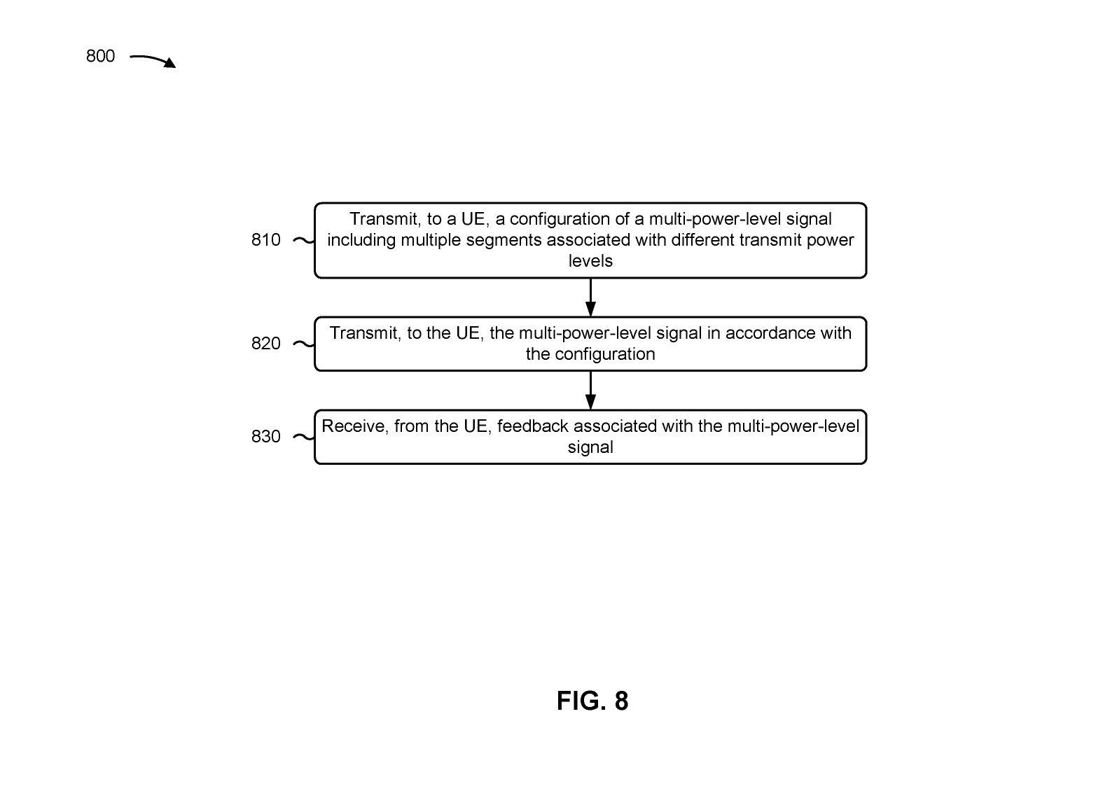

The network node 110, the processing system 145 of the network node 110, the UE 120, the processing system 140 of the UE 120, the CU 210, the DU 230, the RU 240, or any other component(s) of FIG. 1 or FIG. 2 may implement one or more techniques or perform one or more operations associated with a multi-power-level signal, as described in more detail elsewhere herein. For example, the processing system 145 of the network node 110, the processing system 140 of the UE 120, the CU 210, the DU 230, or the RU 240 may perform or direct operations of, for example, process 500 of FIG. 5, process 600 of FIG. 6, process 700 of FIG. 7, process 800 of FIG. 8, or other processes as described herein (alone or in conjunction with one or more other processors). Memory of the network node 110 may store data and program code (or instructions) for the network node 110, the CU 210, the DU 230, or the RU 240. In some examples, the memory of the network node 110 may store data relating to a UE 120, such as RRC state information or a UE context. Memory of a UE 120 may store data and program code (or instructions) for the UE 120, such as context information. In some examples, the memory of the UE 120 or the memory of the network node 110 may include a non-transitory computer-readable medium storing a set of instructions for wireless communication. For example, the set of instructions, when executed by one or more processors (for example, of the processing system 145 or the processing system 140) of the network node 110, the UE 120, the CU 210, the DU 230, or the RU 240, may cause the one or more processors to perform process 500 of FIG. 5, process 600 of FIG. 6, process 700 of FIG. 7, process 800 of FIG. 8, or other processes as described herein. In some examples, executing instructions may include running the instructions, converting the instructions, compiling the instructions, or interpreting the instructions, among other examples.

In some aspects, the UE 120 includes means for receiving, from a network node, a configuration of a multi-power-level signal including multiple segments associated with different transmit power levels; or means for transmitting, to the network node, the multi-power-level signal in accordance with the configuration.

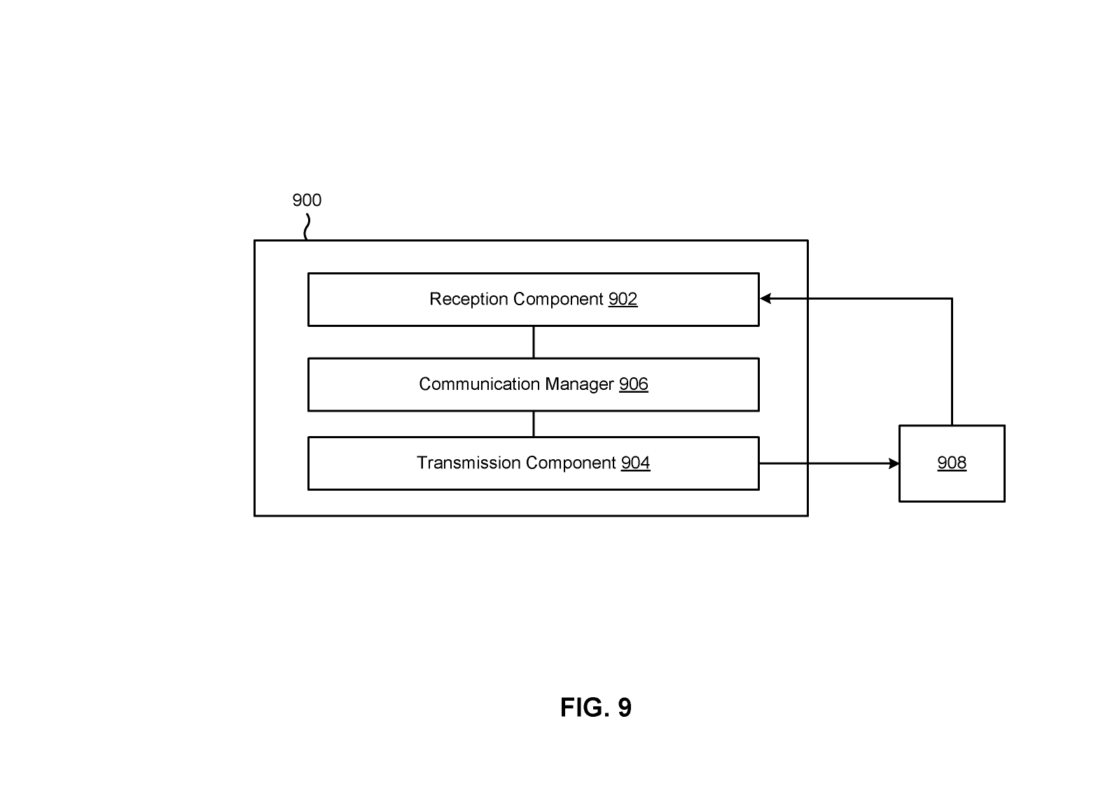

In some aspects, the UE 120 includes means for receiving, from a network node, a configuration of a multi-power-level signal including multiple segments associated with different transmit power levels; means for receiving, from the network node, the multi-power-level signal in accordance with the configuration; or means for transmitting, to the network node, feedback associated with the multi-power-level signal. The means for the UE 120 to perform operations described herein may include, for example, one or more of communication manager 150, processing system 140, a radio, one or more RF chains, one or more transceivers, one or more antennas, one or more modems, a reception component (for example, reception component 902 depicted and described in connection with FIG. 9), or a transmission component (for example, transmission component 904 depicted and described in connection with FIG. 9), among other examples.

In some aspects, the network node 110 includes means for transmitting, to a UE, a configuration of a multi-power-level signal including multiple segments associated with different transmit power levels; or means for receiving, from the UE, the multi-power-level signal in accordance with the configuration.

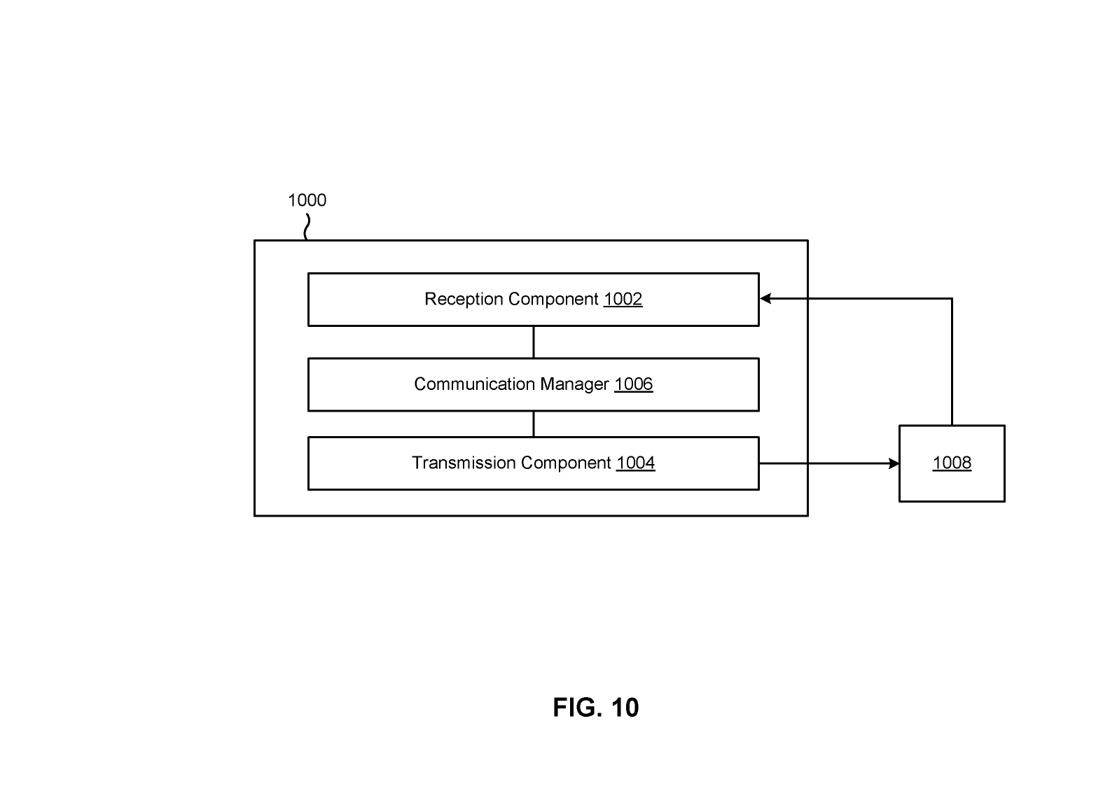

In some aspects, the network node 110 includes means for transmitting, to a UE, a configuration of a multi-power-level signal including multiple segments associated with different transmit power levels; means for transmitting, to the UE, the multi-power-level signal in accordance with the configuration; or means for receiving, from the UE, feedback associated with the multi-power-level signal. The means for the network node 110 to perform operations described herein may include, for example, one or more of communication manager 155, processing system 145, a radio, one or more RF chains, one or more transceivers, one or more antennas, one or more modems, a reception component (for example, reception component 1002 depicted and described in connection with FIG. 10), or a transmission component (for example, transmission component 1004 depicted and described in connection with FIG. 10), among other examples.

In some aspects, a wireless communication device may transmit multi-power-level signals that enable faster (e.g., as compared with closed-loop power control using multiple TPC commands) assessment and mitigation of receiver RF front end impairments. A multi-power-level signal is a signal transmitted with multiple power levels. In some aspects, a multi-power-level signal includes multiple segments associated with different power levels. That is, the multiple segments of the multi-power-level signal include at least one segment associated with (e.g., transmitted using) a first transmit power level and at least one other segment associated with (e.g., transmitted using) a second transmit power level that is different from the first transmit power level. The multi-power-level signal may be used for probing and mitigating receiver RF impairment impacts. The multi-power-level signal can be used to quickly assess power regions where the receiver front end saturates or enters a non-linear regime. The multi-power-level signal can be used to implement faster closed-loop power control. The multi-power-level signal can quickly adapt to the varying channel conditions.

In an example use case, a multi-power-level signal may be used to probe RF impairment and determine a best power region for operation of a low resolution (e.g., 1-bit) ADC-based all-digital receive (Rx) array for channel estimation followed by data detection. In this example use case, a low resolution (e.g., 1-bit) ADC-based uplink receiver may receive a transmitted (e.g., by a UE) multi-power-level reference signal (RS) sequence. In a low uplink signal-to-noise ratio (SNR) regime, receiver thermal noise is dominant, so the RS (e.g., pilot) sequence mean squared error (MSE) decreases with increases in amplitude (e.g., RS sequence transmit power). In a high SNR regime, receiver quantization noise is dominant, so the RS sequence MSE increases with increases in amplitude. RS sequence transmissions with tailored multiple power levels and their respective repetition factors allow a network node to empirically estimate MSEs at the different power levels and determine a regime of operation in a robust manner.

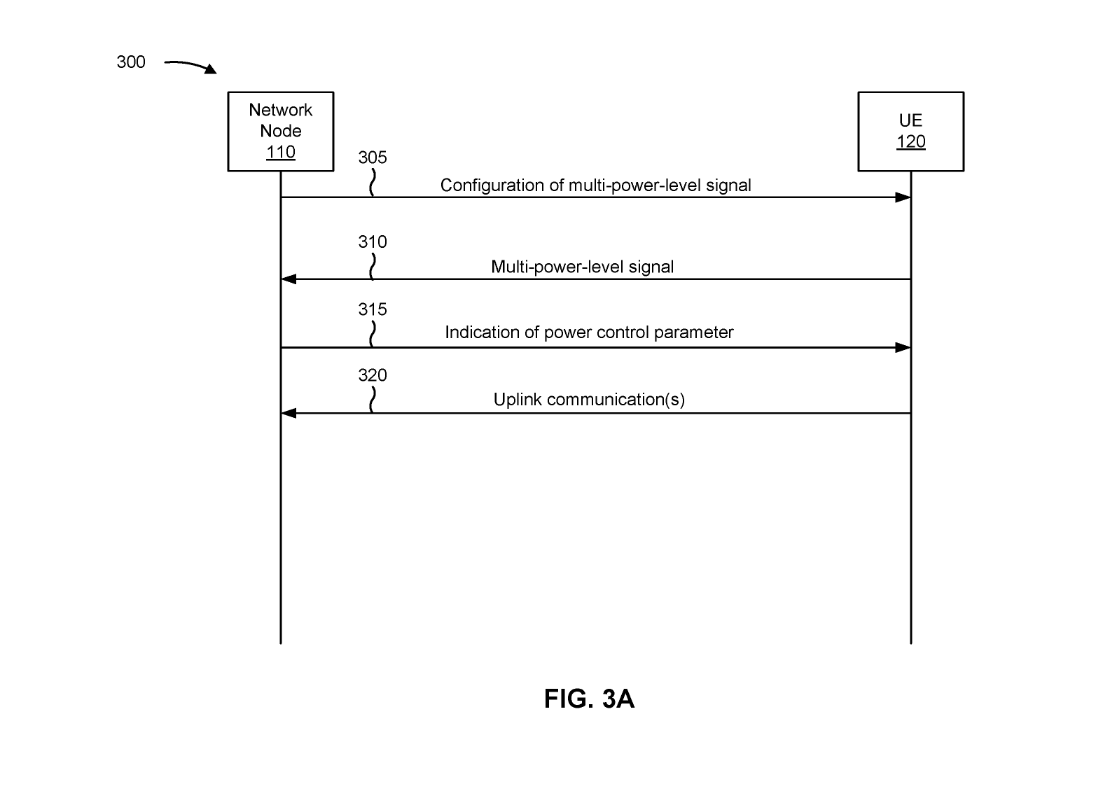

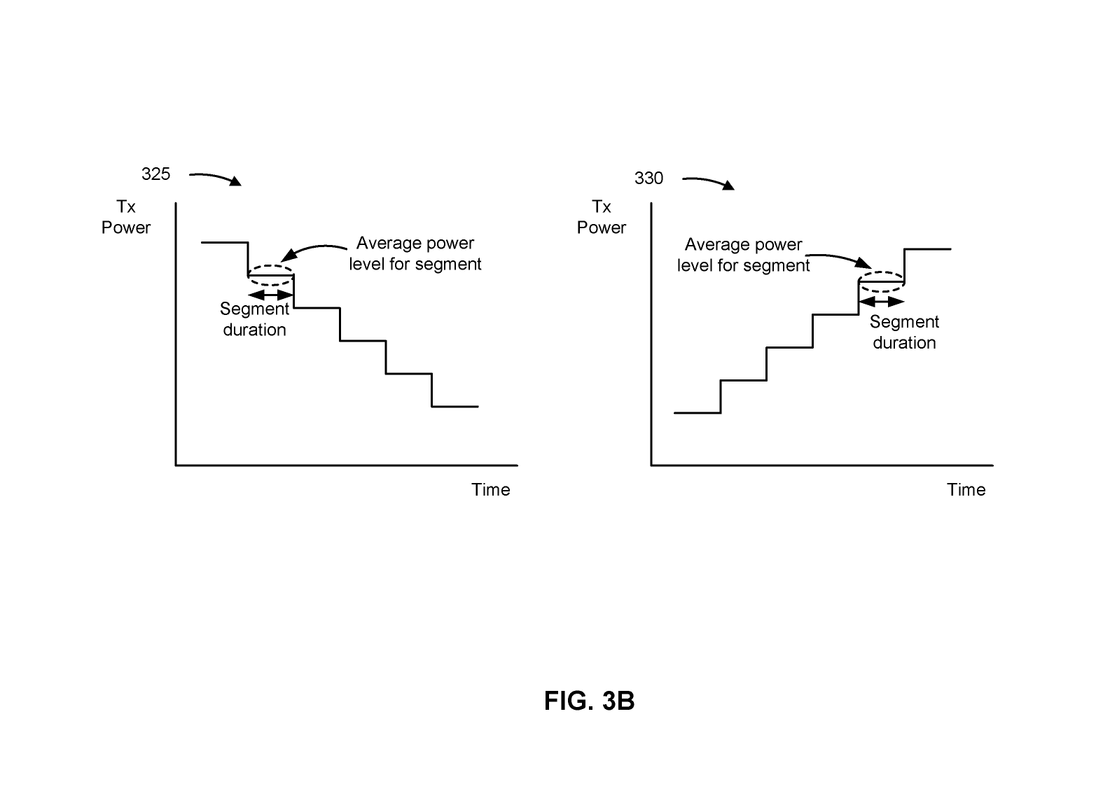

FIGS. 3A-3B are diagrams illustrating examples associated with an uplink multi-power-level signal. As shown in FIG. 3A, example 300 includes communication between a network node 110 and a UE 120. In some aspects, the network node 110 and the UE 120 may be included in a wireless communication network, such as wireless communication network 100. The network node 110 and the UE 120 may communicate via a wireless access link, which may include an uplink and a downlink.

As shown in FIG. 3A, and by reference number 305, the network node 110 may transmit, and the UE 120 may receive, a configuration of a multi-power-level signal. For example, the network node 110 may transmit, and the UE 120 may receive, configuration information indicating the configuration of the multi-power-level signal. In some aspects, the UE 120 may receive the configuration information via one or more of system information signaling (for example, a master information block (MIB) or a system information block (SIB), among other examples), RRC signaling, MAC signaling (for example, one or more MAC-CEs), or physical layer signaling (for example, DCI), among other examples.

In some aspects, the configuration information may indicate one or more candidate configurations or communication parameters for the multi-power-level signal. In some aspects, the one or more candidate configurations or communication parameters may be selected, activated, or deactivated by a subsequent indication. For example, the subsequent indication may select a candidate configuration or communication parameter from the one or more candidate configurations or communication parameters. In some aspects, the subsequent indication may include a dynamic indication, such as one or more MAC-CEs or one or more DCI messages, among other examples.

In some aspects, the network node 110 may configure the UE 120 (e.g., via the configuration of the multi-power-level signal) to transmit the multi-power-level signal to enable the network node 110 to quickly probe RF components of the network node 110 and identify the best operating points. The configured multi-power-level signal may be a reference signal, control signal (e.g., PUCCH), data signal (e.g., PUSCH), or a combination thereof. The multi-power-level signal may include multiple segments. The multiple segments of the multi-power-level signal may be associated with different transmit powers (e.g., the UE 120 may be configured to transmit at least one segment of the multi-power-level signal using a different transmit power from at least one other segment of the multi-power-level signal). In some aspects, the configuration of the multi-power-level signal may indicate the number/quantity of segments of the multi-power-level signal. For each segment, the network node 110 may configure the segment time duration, frequency span, beam, and/or repetition factors. That is, the configuration may indicate, for each segment of the multiple segments of the multi-power-level signal, a respective time duration for the segment, a frequency span for the segment, a beam for the segment, and/or a repetition factor for the segment.

In some aspects, the configuration may indicate a start time for the multi-power-level signal and an offset of each segment relative to a reference segment. For example, the reference segment may be a first segment of the multi-power-level signal or a previous segment immediately preceding each segment. In some examples, the configuration may indicate the start time for the multi-power-level signal and the configuration may indicate, for each segment of the multiple segments of the multi-power-level signal, a respective offset relative to the reference segment as well as a respective segment duration (e.g., the time duration for the segment). In some aspects, the network node 110 may define/configure a frequency domain mapping of the multi-power-level signal (e.g., a frequency domain mapping of each segment of the multi-power-level signal). For example, the configuration of the multi-power-level signal may indicate a frequency domain mapping that maps each segment, of the multiple segments of the multi-power-level signal, to the frequency domain. For example, the frequency domain mapping may map the segments of the multi-power-level signal to respective frequency resources in the frequency domain. In some other aspects, the frequency domain mapping of the multi-power-level signal may be predefined in a wireless communication standard (e.g., a 3GPP wireless communication standard). For example, a wireless communication standard may define an implicit mapping of segments of the multi-power-level signal to the frequency domain.

In some aspects, for each segment, the network node 110 may configure the average power level over the segment duration. For example, the configuration may indicate, for each segment of the multiple segments of the multi-power-level signal, a respective average transmit power level over the segment duration of the segment. In some aspects, a multi-power-level reference signal can be configured using a CSI resource configuration framework. For example, in a case in which the multi-power-level signal is a multi-power-level reference signal, the configuration of the multi-power-level signal may be included in a CSI resource configuration.

In some aspects, the network node 110 may indicate or configure (e.g., in the configuration of the multi-power-level signal) different transmit error vector magnitude (EVM) requirements for different segments of the multi-power-level signal. That is, at least one segment of the multi-power-level signal may be associated with a different transmit EVM requirement from at least one other segment of the multi-power-level signal. In the segments received at high SNR, the received SNR can be high due to good geometry or due to high transmit power levels. In this case, if expected/anticipated receiver RF impairment (such as quantization distortion) is dominant (e.g., and there is high receiver thermal noise), then the transmit EVM requirement may be relaxed. This relaxes a backoff requirement on the PA of the UE 120, which could otherwise be required to maintain stricter EVM. At other operating regimes (e.g., lower or moderate received SNR), transmit EVM requirements may be stricter. The use of different EVM requirements may depend on a type of impairments to be estimated or probed by the network node 110 based on the multi-power-level signal. Hence, flexibility of associating different segments of the multi-power-level signal with different transmit EVM requirements may be useful. In some aspects, such EVM requirements for the different segments of the multi-power-level signal may be defined in a wireless communication standard (e.g., a 3GPP standard) or configured for the UE 120 (e.g., as one or more look-up tables (LUTs)) in the configuration information and dynamically indicated to the UE 120 by the network node 110.

In some aspects, the multi-power-level signal may include a ramp-down RS sequence. As shown by reference number 325 in FIG. 3B, a ramp-down RS sequence is a sequence of RSs with decreasing power levels. In this case, the average power level (e.g., transmit power level) for each segment decreases over a set of segments corresponding to the ramp-down RS sequence. In some aspects, the multi-power-level signal may include a ramp-up RS sequence. As shown by reference number 330 in FIG. 3B, a ramp-up RS sequence is a sequence of RSs with increasing power levels. In this case, the average power level (e.g., transmit power level) for each segment increases over a set of segments corresponding to the ramp-up RS sequence. In some aspects, combinations of ramp-up and ramp-down RS sequences can be used for the multi-power-level signal. For example, the multi-power-level signal can be stitched together as a combination of segments from such sequences. In such examples, the multi-power-level signal may include one or more ramp-down RS sequences and one or more ramp-up RS sequences.

As further shown in FIG. 3A, and by reference number 310, the UE 120 may transmit, and the network node 110 may receive, the multi-power-level signal in accordance with the configuration of the multi-power-level signal. For example, the UE 120 may transmit different segments of the multi-power-level signal using different transmit power levels in accordance with the average power levels for the segments indicated in the configuration information. The UE 120 may transmit the segments of the multi-power-level signal in accordance with the time information (e.g., time duration for each segment, start time for the multi-power-level signal, and/or time offset for each segment), frequency information (e.g., the frequency span for each segment), beam information, and/or repetitions factors indicated in the configuration of the multi-power-level signal. In some aspects, the UE 120 may transmit the segments of the multi-power-level signal in accordance with the different transmit EVM requirements associated with different segments of the multi-power-level signal.

In some aspects, the network node 110 may determine RF impairments based on the multi-power-level signal received from the UE 120. For example, the network node 110 may estimate RF impairments (e.g., non-linearities, phase noise, I/Q imbalance, and/or adjacent channel interference, among other examples) associated with one or more RF components (e.g., ADCs, DACs, LNAs, RF filters, PLLs, and/or PAs, among other examples) of the network node 110 at different power levels based on the multi-power-level signal received from the UE 120. Based upon the determination of the RF impairments by the network node, the network node 110 may initiate an appropriate resource allocation setting (e.g., power control parameter) to be used by the UE 120 for transmitting one or more uplink communications. For example, the network node 110 may determine a best power region of operation for the UE 120 based on the estimated RF impairments at the different power levels.

As further shown in FIG. 3A, and by reference number 315, the network node 110 may transmit, and the UE 120 may receive, an indication of a power control parameter. The power control parameter may indicate a transmit power to be used by the UE 120 for one or more uplink communications. In some aspects, the power control parameter may be based at least in part on the multi-power-level signal. For example, the power control parameter may indicate a transmit power corresponding to the best power region of operation for the UE 120 determined by the network node 110 based on the RF impairments estimated at the different power levels using the multi-power-level signal.

As further shown in FIG. 3A, and by reference number 320, the UE 120 may transmit one or more uplink communications in accordance with the power control parameter, and the network node 110 may receive the one or more uplink communications. For example, the UE 120 may transmit the one or more uplink communications using the transmit power indicated by the power control parameter.

As indicated above, FIGS. 3A-3B are provided as examples. Other examples may differ from what is described with respect to FIGS. 3A-3B.

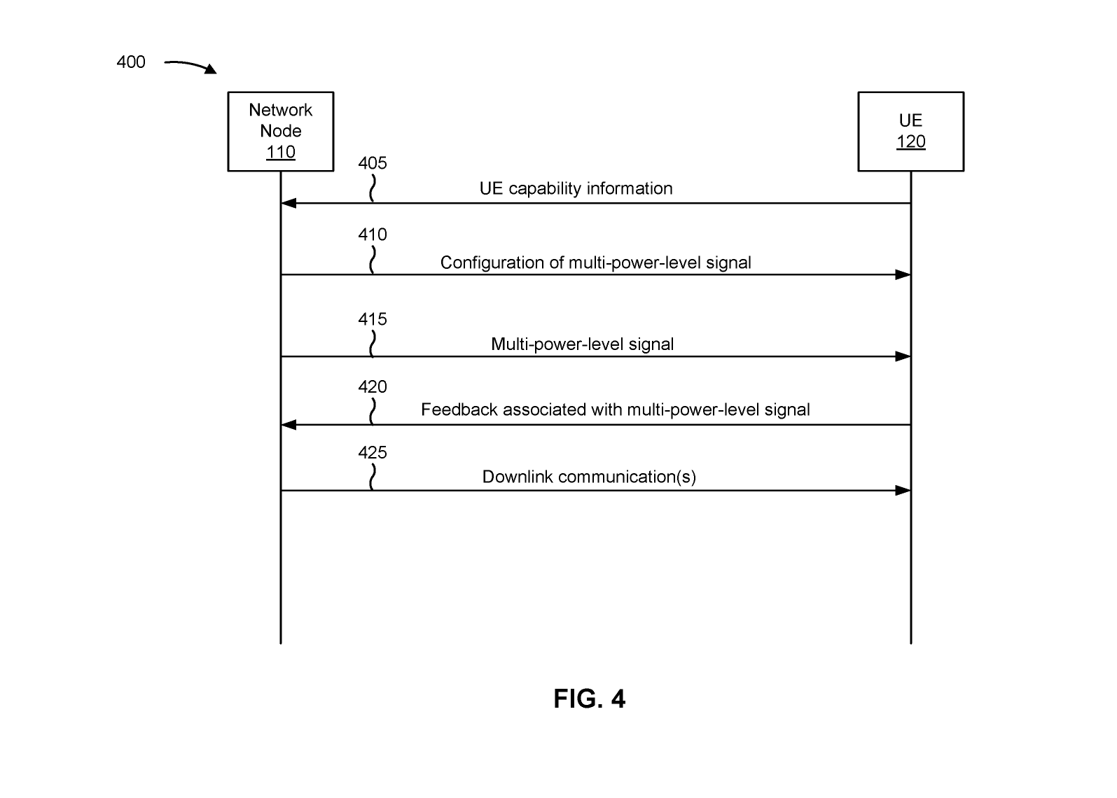

FIG. 4 is a diagram illustrating an example 400 associated with a downlink multi-power-level signal. As shown in FIG. 4, example 400 includes communication between a network node 110 and a UE 120. In some aspects, the network node 110 and the UE 120 may be included in a wireless communication network, such as wireless communication network 100. The network node 110 and the UE 120 may communicate via a wireless access link, which may include an uplink and a downlink.

As shown in FIG. 4, and by reference number 405, the UE 120 may transmit, and the network node 110 may receive, UE capability information associated with a capability of the UE 120 for receiving a downlink multi-power-level signal. The UE capability information may be included in a capability report. In some aspects, the UE capability information may be transmitted via an uplink communication, a sidelink communication, a unicast communication, a broadcast communication, a UE assistance information (UAI) communication, a UCI communication, a sidelink control information (SCI) communication, a MAC-CE communication, an RRC communication, a PUCCH, a PUSCH, a physical sidelink control channel (PSCCH), or a physical sidelink shared channel (PSSCH), among other examples. The UE capability information may indicate one or more parameters associated with respective capabilities of the UE 120. The one or more parameters may be indicated via respective information elements (IEs) included in the capability report.

The UE capability information may indicate whether the UE 120 supports a feature or one or more parameters related to the feature. For example, the UE capability information may indicate a capability or parameter associated with receiving a downlink multi-power-level signal. In some aspects, the UE capability information may indicate a minimum segment duration supported by the UE 120 for each segment of multiple segments included in the downlink multi-power-level signal to be received by the UE 120. For example, the minimum segment duration may correspond to a minimum segment duration sufficient for the UE 120 to perform for metric estimation based on the downlink multi-power-level signal with a desired or acceptable level of reliability. Additionally, or alternatively, the UE capability information may indicate a minimum number/quantity of samples supported by the UE 120 for each segment of the downlink multi-power-level signal. For example, the minimum number of samples may correspond to a minimum number of received samples for each segment that is sufficient for the UE 120 to perform for metric estimation with a desired or acceptable level of reliability. Additionally, or alternatively, the UE capability information may indicate one or more minimum time offsets required before one or more metrics and/or CSI computed for a segment can be available for feedback after receiving that segment. For example, the UE capability information a minimum time offset between reception of the downlink multi-power-level signal and transmission of feedback associated with downlink multi-power-level signal.

As further shown in FIG. 4, and by reference number 410, the network node 110 may transmit, and the UE 120 may receive, a configuration of a multi-power-level signal. For example, the network node 110 may transmit, and the UE 120 may receive, configuration information indicating the configuration of the multi-power-level signal. In some aspects, the UE 120 may receive the configuration information via one or more of system information signaling (for example, a master information block (MIB) or a system information block (SIB), among other examples), RRC signaling, MAC signaling (for example, one or more MAC-CEs), or physical layer signaling (for example, DCI), among other examples.

In some aspects, the configuration information may indicate one or more candidate configurations or communication parameters for the multi-power-level signal. In some aspects, the one or more candidate configurations or communication parameters may be selected, activated, or deactivated by a subsequent indication. For example, the subsequent indication may select a candidate configuration or communication parameter from the one or more candidate configurations or communication parameters. In some aspects, the subsequent indication may include a dynamic indication, such as one or more MAC-CEs or one or more DCI messages, among other examples.

In some aspects, the configuration of the multi-power-level signal may be a configuration of a downlink multi-power-level signal that is to be transmitted by the network node 110 to allow the UE 120 and/or the network node 110 to quickly probe RF components of the UE 120 and identify the best operating point (e.g., the best transmission power for downlink transmissions to the UE 120). The network node 110 may configure the UE 120 (e.g., via the configuration of the multi-power-level signal) to receive the downlink multi-power-level signal. For example, the configuration of the downlink multi-power-level signal may be similar to the configuration of the uplink multi-power-level signal described above in connection with FIGS. 3A-3B. The network node 110 may also configure the UE 120 to compute and report one or more metrics associated with the multi-power-level signal. For example, the configuration information (e.g., the multi-power-level signal configuration) may indicate one or more metrics to be computed by the UE 120 and/or feedback to be reported by the UE 120, as described in greater detail below in connection with reference number 420.

In some aspects, the configured multi-power-level signal may be a reference signal, control signal (e.g., PDCCH), data signal (e.g., PDSCH), or a combination thereof. The multi-power-level signal may include multiple segments. The multiple segments of the multi-power-level signal may be associated with different transmit powers (e.g., at least one segment of the multi-power-level signal may be transmitted by the network node 110 using a different transmit power from at least one other segment of the multi-power-level signal). In some aspects, the configuration of the multi-power-level signal may be based at least in part on the UE capability information. In some aspects, the configuration of the multi-power-level signal may indicate the number/quantity of segments of the multi-power-level signal. Additionally, or alternatively, the configuration may indicate, for each segment of the multiple segments of the multi-power-level signal, a respective time duration for the segment, a frequency span for the segment, a beam for the segment, and/or a repetition factor for the segment. Additionally, or alternatively, the configuration may indicate, for each segment of the multiple segments of the multi-power-level signal, a respective average transmit power level over the segment duration of the segment.

In some aspects, the configuration may indicate a start time for the multi-power-level signal and an offset of each segment relative to a reference segment. For example, the reference segment may be a first segment of the multi-power-level signal or a previous segment immediately preceding each segment. In some examples, the configuration may indicate the start time for the multi-power-level signal and the configuration may indicate, for each segment of the multiple segments of the multi-power-level signal, a respective offset relative to the reference segment as well as a respective segment duration (e.g., the time duration for the segment). In some aspects, the network node 110 may define/configure a frequency domain mapping of the multi- power-level signal (e.g., a frequency domain mapping of each segment of the multi-power-level signal). For example, the configuration of the multi-power-level signal may indicate a frequency domain mapping that maps each segment, of the multiple segments of the multi-power-level signal, to the frequency domain. For example, the frequency domain mapping may map the segments of the multi-power-level signal to respective frequency resources in the frequency domain. In some other aspects, the frequency domain mapping of the multi-power-level signal may be predefined in a wireless communication standard (e.g., a 3GPP wireless communication standard). For example, a wireless communication standard may define an implicit mapping of segments of the multi-power-level signal to the frequency domain.

In some aspects, a multi-power-level reference signal can be configured using a CSI resource configuration framework or a CSI report configuration framework. For example, in a case in which the multi-power-level signal is a multi-power-level reference signal, the configuration of the multi-power-level signal may be included in a CSI resource configuration or a CSI report configuration.

In some aspects, similar to as described above in connection with FIGS. 3A-3B, the different segments of the multi-power-level signal may be associated with different EVM requirements. In some aspects, the configuration of the multi-power-level signal may indicate the different EVM requirements for the different segments of the multi-power-level signal. In some aspects, the EVM requirements for the different segments of the multi-power-level signal may be defined in a wireless communication standard (e.g., a 3GPP standard) or configured (e.g., as one or more look-up tables (LUTs)) in the configuration information and dynamically indicated to the UE 120 by the network node 110.

In some aspects, the multi-power-level signal may include a ramp-down RS sequence (e.g., a sequence of RSs with decreasing power levels). In this case, the average power level for each segment decreases over a set of segments corresponding to the ramp-down RS sequence. In some aspects, the multi-power-level signal may include a ramp-up RS sequence (e.g., a sequence of RSs with increasing power levels). In this case, the average power level for each segment increases over a set of segments corresponding to the ramp-up RS sequence. In some aspects, combinations of ramp-up and ramp-down RS sequences can be used for the multi-power-level signal. For example, the multi-power-level signal can be stitched together as a combination of segments from such sequences.

As further shown in FIG. 4, and by reference number 415, the network node 110 may transmit, and the UE 120 may receive, the multi-power-level signal in accordance with the configuration. For example, the network node 110 may transmit different segments of the multi-power-level signal using different transmit power levels in accordance with the power levels for the segments indicated in the configuration information. The network node 110 may transmit the segments of the multi-power-level signal in accordance with the time information (e.g., time duration for each segment, start time for the multi-power-level signal, and/or time offset for each segment), frequency information (e.g., the frequency span for each segment), beam information, and/or repetitions factors indicated in the configuration of the multi-power-level signal. In some aspects, the network node 110 may transmit the segments of the multi-power-level signal in accordance with the different transmit EVM requirements associated with different segments of the multi-power-level signal.

As further shown in FIG. 4, and by reference number 420, the UE 120 may transmit, and the network node 110 may receive, feedback associated with the multi-power-level signal. For example, the feedback may be associated with an accuracy of receiving the multi-power-level signal. In some aspects, the UE 120 may be configured to transmit, to the network node 110, feedback/reporting based on the received multi-power-level signal. In some aspects, the UE 120 may be configured to compute a metric (e.g., at least one metric) for each segment of the multi-power-level signal received by the UE 120, and report the metric to the network node 110. In such examples, the feedback may include a report that indicates a respective value of the metric (e.g., at least one metric) for each of one or more segments of the multiple segments of the multi-power-level signal. In some examples, if the multi-power-level signal is a reference signal, the metric may be an MSE for each segment of the multi-power-level signal. In this case, the UE 120 may additionally be configured to feedback a CSI report that includes a plurality of CSI sub-reports, each including CSI information (CQI, signal-to-interference-plus-noise ratio (SINR), RI, and/or PMI, among other examples) for a respective segment of the multi-power-level signal.

In some aspects, for control (e.g., PDCCH) and data (e.g., PDSCH) signals, the metric may be an error-rate (e.g., a block error rate (BLER) or a symbol error rate (SER)) or a mis-detection rate. In some examples, the feedback transmitted by the UE 120 may include ACKs/NACKs for decoding the PDCCHs/PDSCHs to allow the network node 110 to calculate the BLER or mis-detection rate for each segment. In this case, the feedback may include a respective ACK or NACK associated with decoding a control channel (e.g., PDCCH) or a data channel (e.g., PDSCH) for each segment of the multiple segments of the multi-power-level signal. In some examples, the PDSCH/PDCCH may be divided into smaller blocks (e.g., sub-blocks), a respective cyclic redundancy check (CRC) may be associated with each small block, and the UE 120 may be configured to transmit ACKs/NACKs for each small block (e.g., each sub-block) to allow the network node 110 to calculate (or infer) the SER. In this case, the feedback may include ACKs or NACKs associated with decoding respective sub-blocks of a control channel (e.g., PDCCH) or a data channel (e.g., PDSCH) for each segment of the multiple segments of the multi-power-level signal. Alternatively, in some examples, these metrics (e.g., BLER, SER, or mis-detection rate) may be reported by the UE as a part of a CSI report (e.g., assuming that the UE 120 is aware of the content of the multi-power-level signal).

In some aspects, the metric(s) (e.g., MSE, BLER, SER, or mis-detection rate) can be reported for all segments of the multi-power-level signal. In this case, the feedback may include a report that indicates respective values of at least one metric (e.g., MSE, BLER, SER, or mis-detection rate) for all of the segments of the multi-power-level signal. In some aspects, the metric(s) (e.g., MSE, BLER, SER, or mis-detection rate) can be reported for a selected (or pruned) set of segments of the multi-power-level signal, such as the top-k segments, in accordance with the computed metric(s). In some examples, for a multi-power-level signal that is a combination of two or more of a RS, a control signal, or a data signal, the UE 120 may be configured to perform a top-k operation or some selection/pruning operation separately for each type of segments in accordance with their respective metrics (e.g., separately for each of data segments, control segments, and RS segments, respectively). For example, in a case in which the multi-power-level signal includes a first set of segments associated with a first type of signal (e.g., RS, control signal, or data signal) and a second set of segments associated with a second type of signal (e.g., RS, control signal, or data signal), the feedback map include a report that indicates respective values of a first metric (e.g., a metric associated with the first type of signal) for each of a selected subset (e.g., a top-k) of the first set of segments (e.g., selected in accordance with the first metric) and respective values of a second metric (e.g., a metric associated with the second type of signal) for each of a selected subset (e.g., a top-k) of the second set of segments (e.g., selected in accordance with the second metric).

In some aspects, the UE 120 may perform RF impairment estimation based on reception of the multi-power-level signal. For example, the UE 120 may estimate RF impairments at multiple different power levels based on the received multi-power-level signal. The impairment estimation may account for underlying current channel conditions. In some aspects, the UE 120 may identify a transmit power level (e.g., for downlink communications) corresponding to the best operating point of the RF components (e.g., ADCs, DACs, LNAs, RF filters, PLLs, and/or PAs, among other examples) of the UE 120 based on the estimated RF impairments at the different power levels, and recommend the identified power level to the network node 110. In this case, the feedback associated with the multi-power-level signal may include an indication of the recommended transmit power level.

The set of computed metrics, along with the power levels of the segments of the multi-power-level signal, may be used as inputs to a processing unit to determine/characterize RF front-end impairments of the UE. In some aspects, the processing unit that determines/characterizes the RF front-end impairments may be at the UE 120 (e.g., the UE 120 determines/characterizes the RF front-end impairments based on the multi-power-level signal). In this case, the UE 120 may estimate the RF impairments based at least in part on the respective values for the metric(s) computed for the segments of the multi-power-level signal. The UE 120 may then identify the recommended transmit power level for downlink communications based on the estimated RF impairments, and transmit, to the network node 110, feedback including the recommended transmit power level. In some other aspects, the processing unit that determines/characterizes the RF front-end impairments may be at the network node 110 (e.g., the network node 110 determines/characterizes the RF front-end impairments based on the feedback received from the UE 120). In this case, the UE 120 may transmit feedback indicating the values of the metric(s) computed for all or a selected set of the segments of the multi-power-level signal, and the network node 110 may estimate the RF impairments associated with the RF components of the UE 120 based at least in part on the values of the metric(s) received from the UE 120. The network node 110 may then determine the transmit power level for downlink communications to the UE 120 based on the estimated RF impairments.

As further shown in FIG. 4, and by reference number 425, the network node 110 may transmit one or more downlink communications with a transmit power based at least in part on the feedback associated with the multi-power-level signal, and the UE 120 may receive the one or more downlink communications. In some aspects, the feedback associated with the multi-power-level signal may include an indication of a recommended transmit power level, and the network node 110 may determine the transmit power level for the one or more downlink communications based at least in part on the recommended transmit power level. In some aspects, the feedback may indicate values of at least one metric computed for all or a selected set of segments of the multi-power-level signal. In this case, the network node 110 may estimate RF impairments associated with the RF components of the UE 120 based at least in part on the values of the at least one metric and determine the transmit power for the one or more downlink communications based on the estimated RF impairments.

As indicated above, FIG. 4 is provided as an example. Other examples may differ from what is described with respect to FIG. 4.

FIG. 5 is a diagram illustrating an example process 500 performed, for example, at a UE or an apparatus of a UE. Example process 500 is an example where the apparatus or the UE (e.g., UE 120) performs operations associated with a multi-power-level signal.

As shown in FIG. 5, in some aspects, process 500 may include receiving, from a network node, a configuration of a multi-power-level signal including multiple segments associated with different transmit power levels (block 510). For example, the UE (e.g., using reception component 902 or communication manager 906, depicted in FIG. 9) may receive, from a network node, a configuration of a multi-power-level signal including multiple segments associated with different transmit power levels, as described above.

As further shown in FIG. 5, in some aspects, process 500 may include transmitting, to the network node, the multi-power-level signal in accordance with the configuration (block 520). For example, the UE (e.g., using transmission component 904 or communication manager 906, depicted in FIG. 9) may transmit, to the network node, the multi-power-level signal in accordance with the configuration, as described above.

Process 500 may include additional aspects, such as any single aspect or any combination of aspects described below or in connection with one or more other processes described elsewhere herein.

In a first aspect, the multi-power-level signal is a reference signal, a control signal, a data signal, or a combination thereof.

In a second aspect, alone or in combination with the first aspect, the configuration indicates a quantity of the multiple segments.

In a third aspect, alone or in combination with one or more of the first and second aspects, the configuration indicates, for each segment of the multiple segments, at least one of a respective time duration for the segment, a frequency span for the segment, a beam for the segment, or a repetition factor for the segment.

In a fourth aspect, alone or in combination with one or more of the first through third aspects, the configuration indicates a start time for the multi-power-level signal, and the configuration indicates, for each segment of the multiple segments, a respective offset relative to a reference segment, and a respective segment duration.

In a fifth aspect, alone or in combination with one or more of the first through fourth aspects, the configuration indicates a frequency domain mapping associated with the multi-power-level signal, and the frequency domain mapping defines a mapping of each segment, of the multiple segments, to the frequency domain.

In a sixth aspect, alone or in combination with one or more of the first through fifth aspects, the configuration indicates, for each segment of the multiple segments, a respective average transmit power level over a segment duration of the segment.

In a seventh aspect, alone or in combination with one or more of the first through sixth aspects, the multi-power-level signal is a multi-power-level reference signal, and the configuration of the multi-power-level signal is included in a channel state information resource configuration.

In an eighth aspect, alone or in combination with one or more of the first through seventh aspects, different segments, of the multiple segments, are associated with different transmit EVM requirements.

In a ninth aspect, alone or in combination with one or more of the first through eighth aspects, the configuration indicates the different transmit EVM requirements associated with the different segments of the multiple segments.

In a tenth aspect, alone or in combination with one or more of the first through ninth aspects, the multi-power-level signal includes a ramp-up reference signal sequence, a ramp-down reference signal sequence, or a combination thereof.

In an eleventh aspect, alone or in combination with one or more of the first through tenth aspects, process 500 includes receiving, from the network node, an indication of a power control parameter based at least in part on the multi-power-level signal.

In a twelfth aspect, alone or in combination with one or more of the first through eleventh aspects, process 500 includes transmitting, to the network node, an uplink communication in accordance with the power control parameter.

Although FIG. 5 shows example blocks of process 500, in some aspects, process 500 may include additional blocks, fewer blocks, different blocks, or differently arranged blocks than those depicted in FIG. 5. Additionally, or alternatively, two or more of the blocks of process 500 may be performed in parallel.

FIG. 6 is a diagram illustrating an example process 600 performed, for example, at a network node or an apparatus of a network node. Example process 600 is an example where the apparatus or the network node (e.g., network node 110) performs operations associated with a multi-power-level signal.

As shown in FIG. 6, in some aspects, process 600 may include transmitting, to a UE, a configuration of a multi-power-level signal including multiple segments associated with different transmit power levels (block 610). For example, the network node (e.g., using transmission component 1004 or communication manager 1006, depicted in FIG. 10) may transmit, to a UE, a configuration of a multi-power-level signal including multiple segments associated with different transmit power levels, as described above.

As further shown in FIG. 6, in some aspects, process 600 may include receiving, from the UE, the multi-power-level signal in accordance with the configuration (block 620). For example, the network node (e.g., using reception component 1002 or communication manager 1006, depicted in FIG. 10) may receive, from the UE, the multi-power-level signal in accordance with the configuration, as described above.

Process 600 may include additional aspects, such as any single aspect or any combination of aspects described below or in connection with one or more other processes described elsewhere herein.

In a first aspect, the multi-power-level signal is a reference signal, a control signal, a data signal, or a combination thereof.

In a second aspect, alone or in combination with the first aspect, the configuration indicates a quantity of the multiple segments.

In a third aspect, alone or in combination with one or more of the first and second aspects, the configuration indicates, for each segment of the multiple segments, at least one of a respective time duration for the segment, a frequency span for the segment, a beam for the segment, or a repetition factor for the segment.

In a fourth aspect, alone or in combination with one or more of the first through third aspects, the configuration indicates a start time for the multi-power-level signal, and the configuration indicates, for each segment of the multiple segments, a respective offset relative to a reference segment, and a respective segment duration.

In a fifth aspect, alone or in combination with one or more of the first through fourth aspects, the configuration indicates a frequency domain mapping associated with the multi-power-level signal, and the frequency domain mapping defines a mapping of each segment, of the multiple segments, to the frequency domain.

In a sixth aspect, alone or in combination with one or more of the first through fifth aspects, the configuration indicates, for each segment of the multiple segments, a respective average transmit power level over a segment duration of the segment.

In a seventh aspect, alone or in combination with one or more of the first through sixth aspects, the multi-power-level signal is a multi-power-level reference signal, and the configuration of the multi-power-level signal is included in a channel state information resource configuration.

In an eighth aspect, alone or in combination with one or more of the first through seventh aspects, different segments, of the multiple segments, are associated with different transmit EVM requirements.

In a ninth aspect, alone or in combination with one or more of the first through eighth aspects, the configuration indicates the different transmit EVM requirements associated with the different segments of the multiple segments.

In a tenth aspect, alone or in combination with one or more of the first through ninth aspects, the multi-power-level signal includes a ramp-up reference signal sequence, a ramp-down reference signal sequence, or a combination thereof.

In an eleventh aspect, alone or in combination with one or more of the first through tenth aspects, process 600 includes transmitting, to the UE, an indication of a power control parameter based at least in part on the multi-power-level signal.

In a twelfth aspect, alone or in combination with one or more of the first through eleventh aspects, process 600 includes receiving, from the UE, an uplink communication transmitted in accordance with the power control parameter.

Although FIG. 6 shows example blocks of process 600, in some aspects, process 600 may include additional blocks, fewer blocks, different blocks, or differently arranged blocks than those depicted in FIG. 6. Additionally, or alternatively, two or more of the blocks of process 600 may be performed in parallel.

FIG. 7 is a diagram illustrating an example process 700 performed, for example, at a UE or an apparatus of a UE. Example process 700 is an example where the apparatus or the UE (e.g., UE 120) performs operations associated with a multi-power-level signal.

As shown in FIG. 7, in some aspects, process 700 may include receiving, from a network node, a configuration of a multi-power-level signal including multiple segments associated with different transmit power levels (block 710). For example, the UE (e.g., using reception component 902 or communication manager 906, depicted in FIG. 9) may receive, from a network node, a configuration of a multi-power-level signal including multiple segments associated with different transmit power levels, as described above.

As further shown in FIG. 7, in some aspects, process 700 may include receiving, from the network node, the multi-power-level signal in accordance with the configuration (block 720). For example, the UE (e.g., using reception component 902 or communication manager 906, depicted in FIG. 9) may receive, from the network node, the multi-power-level signal in accordance with the configuration, as described above.

As further shown in FIG. 7, in some aspects, process 700 may include transmitting, to the network node, feedback associated with the multi-power-level signal (block 730). For example, the UE (e.g., using transmission component 904 or communication manager 906, depicted in FIG. 9) may transmit, to the network node, feedback associated with the multi-power-level signal, as described above.

Process 700 may include additional aspects, such as any single aspect or any combination of aspects described below or in connection with one or more other processes described elsewhere herein.

In a first aspect, the feedback includes a report indicating a respective value of at least one metric for each of one or more segments of the multiple segments.

In a second aspect, alone or in combination with the first aspect, the multi-power-level signal is a reference signal, and the at least one metric includes a mean square error.

In a third aspect, alone or in combination with one or more of the first and second aspects, the report is a CSI report that includes a respective CSI sub-report indicating CSI information for each of the one or more segments.

In a fourth aspect, alone or in combination with one or more of the first through third aspects, the multi-power-level signal is a control signal or a data signal, and the at least one metric includes at least one of a block error rate, a symbol error rate, or a misdetection rate.

In a fifth aspect, alone or in combination with one or more of the first through fourth aspects, the report is included in a channel state information report.

In a sixth aspect, alone or in combination with one or more of the first through fifth aspects, the report indicates a respective value of the at least one metric for each segment of the multiple segments.

In a seventh aspect, alone or in combination with one or more of the first through sixth aspects, the report indicates a respective value of the at least one metric for each of a selected set of segments of the multiple segments in accordance with the metric.

In an eighth aspect, alone or in combination with one or more of the first through seventh aspects, the multi-power-level signal includes a first set of segments, of the multiple segments, associated with a first type of signal, and a second set of segments, of the multiple segments, associated with a second type of signal, the at least one metric includes a first metric associated with the first type of signal and a second metric associated with the second type of signal, and the report indicates respective values of the first metric for a selected subset of the first set of segments in accordance with the first metric, and respective values of the second metric for a selected subset of the second set of segments in accordance with the second metric.

In a ninth aspect, alone or in combination with one or more of the first through eighth aspects, the multi-power-level signal is a control signal or a data signal, and the feedback includes a respective acknowledgement or negative acknowledgement associated with decoding a control channel or a data channel for each segment of the multiple segments.

In a tenth aspect, alone or in combination with one or more of the first through ninth aspects, the multi-power-level signal is a control signal or a data signal, and the feedback includes acknowledgements or negative acknowledgements associated with decoding respective sub-blocks of a control channel or a data channel for each segment of the multiple segments.

In an eleventh aspect, alone or in combination with one or more of the first through tenth aspects, the feedback indicates a recommended power level.

In a twelfth aspect, alone or in combination with one or more of the first through eleventh aspects, process 700 includes estimating an RF impairment based on the multi-power-level signal, wherein the recommended power level is based on the RF impairment.

In a thirteenth aspect, alone or in combination with one or more of the first through twelfth aspects, estimating the RF impairment includes estimating the RF impairment based on respective values of a metric for the multiple segments and respective power levels for the multiple segments.

In a fourteenth aspect, alone or in combination with one or more of the first through thirteenth aspects, process 700 includes transmitting, to the network node, UE capability information indicating at least one of a minimum segment duration for each segment of the multiple segments included in the multi-power-level signal, a minimum number of samples for each segment of the multiple segments included in the multi-power-level signal, or a minimum time offset between reception of the multi-power-level signal and transmission of the feedback.

In a fifteenth aspect, alone or in combination with one or more of the first through fourteenth aspects, the multi-power-level signal is a reference signal, a control signal, a data signal, or a combination thereof.

In a sixteenth aspect, alone or in combination with one or more of the first through fifteenth aspects, the configuration indicates a quantity of the multiple segments.

In a seventeenth aspect, alone or in combination with one or more of the first through sixteenth aspects, the configuration indicates, for each segment of the multiple segments, at least one of a respective time duration for the segment, a frequency span for the segment, a beam for the segment, or a repetition factor for the segment.

In an eighteenth aspect, alone or in combination with one or more of the first through seventeenth aspects, the configuration indicates a start time for the multi-power-level signal, and the configuration indicates, for each segment of the multiple segments, a respective offset relative to a reference segment and a respective segment duration.

In a nineteenth aspect, alone or in combination with one or more of the first through eighteenth aspects, the configuration indicates a frequency domain mapping associated with the multi-power-level signal, and the frequency domain mapping defines a mapping of each segment, of the multiple segments, to the frequency domain.

In a twentieth aspect, alone or in combination with one or more of the first through nineteenth aspects, the configuration indicates, for each segment of the multiple segments, a respective average transmit power level over a segment duration of the segment.

In a twenty-first aspect, alone or in combination with one or more of the first through twentieth aspects, the multi-power-level signal is a multi-power-level reference signal, and the configuration of the multi-power-level signal is included in a channel state information resource configuration.

In a twenty-second aspect, alone or in combination with one or more of the first through twenty-first aspects, different segments, of the multiple segments, are associated with different transmit EVM requirements.

In a twenty-third aspect, alone or in combination with one or more of the first through twenty-second aspects, the configuration indicates the different transmit EVM requirements associated with the different segments of the multiple segments.

In a twenty-fourth aspect, alone or in combination with one or more of the first through twenty-third aspects, the multi-power-level signal includes a ramp-up reference signal sequence, a ramp-down reference signal sequence, or a combination thereof.

Although FIG. 7 shows example blocks of process 700, in some aspects, process 700 may include additional blocks, fewer blocks, different blocks, or differently arranged blocks than those depicted in FIG. 7. Additionally, or alternatively, two or more of the blocks of process 700 may be performed in parallel.

FIG. 8 is a diagram illustrating an example process 800 performed, for example, at a network node or an apparatus of a network node. Example process 800 is an example where the apparatus or the network node (e.g., network node 110) performs operations associated with a multi-power-level signal.

As shown in FIG. 8, in some aspects, process 800 may include transmitting, to a UE, a configuration of a multi-power-level signal including multiple segments associated with different transmit power levels (block 810). For example, the network node (e.g., using transmission component 1004 or communication manager 1006, depicted in FIG. 10) may transmit, to a UE, a configuration of a multi-power-level signal including multiple segments associated with different transmit power levels, as described above.

As further shown in FIG. 8, in some aspects, process 800 may include transmitting, to the UE, the multi-power-level signal in accordance with the configuration (block 820). For example, the network node (e.g., using transmission component 1004 or communication manager 1006, depicted in FIG. 10) may transmit, to the UE, the multi-power-level signal in accordance with the configuration, as described above.

As further shown in FIG. 8, in some aspects, process 800 may include receiving, from the UE, feedback associated with the multi-power-level signal (block 830). For example, the network node (e.g., using reception component 1002 or communication manager 1006, depicted in FIG. 10) may receive, from the UE, feedback associated with the multi-power-level signal, as described above.

Process 800 may include additional aspects, such as any single aspect or any combination of aspects described below or in connection with one or more other processes described elsewhere herein.

In a first aspect, the feedback includes a report indicating a respective value of at least one metric for each of one or more segments of the multiple segments.

In a second aspect, alone or in combination with the first aspect, the multi-power-level signal is a reference signal, and the at least one metric includes a mean square error.

In a third aspect, alone or in combination with one or more of the first and second aspects, the report is a CSI report that includes a respective CSI sub-report indicating CSI information for each of the one or more segments.

In a fourth aspect, alone or in combination with one or more of the first through third aspects, the multi-power-level signal is a control signal or a data signal, and the at least one metric includes at least one of a block error rate, a symbol error rate, or a misdetection rate.

In a fifth aspect, alone or in combination with one or more of the first through fourth aspects, the report is included in a channel state information report.

In a sixth aspect, alone or in combination with one or more of the first through fifth aspects, the report indicates a respective value of the at least one metric for each segment of the multiple segments.

In a seventh aspect, alone or in combination with one or more of the first through sixth aspects, the report indicates a respective value of the at least one metric for each of a selected set of segments of the multiple segments in accordance with the metric.

In an eighth aspect, alone or in combination with one or more of the first through seventh aspects, the multi-power-level signal includes a first set of segments, of the multiple segments, associated with a first type of signal, and a second set of segments, of the multiple segments, associated with a second type of signal, the at least one metric includes a first metric associated with the first type of signal and a second metric associated with the second type of signal, and the report indicates respective values of the first metric for a selected subset of the first set of segments in accordance with the first metric, and respective values of the second metric for a selected subset of the second set of segments in accordance with the second metric.

In a ninth aspect, alone or in combination with one or more of the first through eighth aspects, the multi-power-level signal is a control signal or a data signal, and the feedback includes a respective acknowledgement or negative acknowledgement associated with decoding a control channel or a data channel for each segment of the multiple segments.

In a tenth aspect, alone or in combination with one or more of the first through ninth aspects, the multi-power-level signal is a control signal or a data signal, and the feedback includes acknowledgements or negative acknowledgements associated with decoding respective sub-blocks of a control channel or a data channel for each segment of the multiple segments.

In an eleventh aspect, alone or in combination with one or more of the first through tenth aspects, the feedback indicates a recommended power level.

In a twelfth aspect, alone or in combination with one or more of the first through eleventh aspects, process 800 includes transmitting, to the UE, a downlink communication with a transmit power level based at least in part on the feedback.

In a thirteenth aspect, alone or in combination with one or more of the first through twelfth aspects, process 800 includes receiving, from the UE, UE capability information indicating at least one of a minimum segment duration for each segment of the multiple segments included in the multi-power-level signal, a minimum number of samples for each segment of the multiple segments included in the multi-power-level signal, or a minimum time offset between reception of the multi-power-level signal and transmission of the feedback.

In a fourteenth aspect, alone or in combination with one or more of the first through thirteenth aspects, the multi-power-level signal is a reference signal, a control signal, a data signal, or a combination thereof.

In a fifteenth aspect, alone or in combination with one or more of the first through fourteenth aspects, the configuration indicates a quantity of the multiple segments.

In a sixteenth aspect, alone or in combination with one or more of the first through fifteenth aspects, the configuration indicates, for each segment of the multiple segments, at least one of a respective time duration for the segment, a frequency span for the segment, a beam for the segment, or a repetition factor for the segment.

In a seventeenth aspect, alone or in combination with one or more of the first through sixteenth aspects, the configuration indicates a start time for the multi-power-level signal, and the configuration indicates, for each segment of the multiple segments, a respective offset relative to a reference segment and a respective segment duration.

In an eighteenth aspect, alone or in combination with one or more of the first through seventeenth aspects, the configuration indicates a frequency domain mapping associated with the multi-power-level signal, and the frequency domain mapping defines a mapping of each segment, of the multiple segments, to the frequency domain.

In a nineteenth aspect, alone or in combination with one or more of the first through eighteenth aspects, the configuration indicates, for each segment of the multiple segments, a respective average transmit power level over a segment duration of the segment.

In a twentieth aspect, alone or in combination with one or more of the first through nineteenth aspects, the multi-power-level signal is a multi-power-level reference signal, and the configuration of the multi-power-level signal is included in a channel state information resource configuration.

In a twenty-first aspect, alone or in combination with one or more of the first through twentieth aspects, different segments, of the multiple segments, are associated with different transmit EVM requirements.

In a twenty-second aspect, alone or in combination with one or more of the first through twenty-first aspects, the configuration indicates the different transmit EVM requirements associated with the different segments of the multiple segments.

In a twenty-third aspect, alone or in combination with one or more of the first through twenty-second aspects, the multi-power-level signal includes a ramp-up reference signal sequence, a ramp-down reference signal sequence, or a combination thereof.

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

FIG. 9 is a diagram of an example apparatus 900 for wireless communication. The apparatus 900 may be a UE, or a UE may include the apparatus 900. In some aspects, the apparatus 900 includes a reception component 902, a transmission component 904, or a communication manager 906, which may be in communication with one another (for example, via one or more buses or one or more other components). In some aspects, the communication manager 906 is the communication manager 150 described in connection with FIG. 1. As shown, the apparatus 900 may communicate with another apparatus 908, such as a UE or a network node (such as a CU, a DU, an RU, or a base station), using the reception component 902 and the transmission component 904. The communication manager 906 may be included in, or implemented via, a processing system (for example, the processing system 140 described in connection with FIG. 1) of the UE.

In some aspects, the apparatus 900 may be configured to perform one or more operations described herein in connection with FIGS. 3-4. Additionally, or alternatively, the apparatus 900 may be configured to perform one or more processes described herein, such as process 500 of FIG. 5, process 700 of FIG. 7, or a combination thereof. In some aspects, the apparatus 900 or one or more components shown in FIG. 9 may include one or more components of the UE described in connection with FIG. 1. Additionally, or alternatively, one or more components shown in FIG. 9 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 902 may receive communications, such as reference signals, control information, data communications, or a combination thereof, from the apparatus 908. The reception component 902 may provide received communications to one or more other components of the apparatus 900. In some aspects, the reception component 902 may perform signal processing on the received communications, and may provide the processed signals to the one or more other components of the apparatus 900. In some aspects, the reception component 902 may include one or more components of the UE described above in connection with FIG. 1, such as a radio, one or more RF chains, one or more transceivers, or one or more modems, each of which may in turn be coupled with one or more antennas of the UE.

The transmission component 904 may transmit communications, such as reference signals, control information, data communications, or a combination thereof, to the apparatus 908. In some aspects, one or more other components of the apparatus 900 may generate communications and may provide the generated communications to the transmission component 904 for transmission to the apparatus 908. In some aspects, the transmission component 904 may perform signal processing on the generated communications, and may transmit the processed signals to the apparatus 908. In some aspects, the transmission component 904 may include one or more components of the UE described above in connection with FIG. 1, such as a radio, one or more RF chains, one or more transceivers, or one or more modems, each of which may in turn be coupled with one or more antennas of the UE described in connection with FIG. 1. In some aspects, the transmission component 904 may be co-located with the reception component 902.

The communication manager 906 may support operations of the reception component 902 or the transmission component 904. For example, the communication manager 906 may receive information associated with configuring reception of communications by the reception component 902 or transmission of communications by the transmission component 904. Additionally, or alternatively, the communication manager 906 may generate or provide control information to the reception component 902 or the transmission component 904 to control reception or transmission of communications.

The reception component 902 may receive, from a network node, a configuration of a multi-power-level signal including multiple segments associated with different transmit power levels. The transmission component 904 may transmit, to the network node, the multi-power-level signal in accordance with the configuration.

The reception component 902 may receive, from the network node, an indication of a power control parameter based at least in part on the multi-power-level signal.

The transmission component 904 may transmit, to the network node, an uplink communication in accordance with the power control parameter.

The reception component 902 may receive, from a network node, a configuration of a multi-power-level signal including multiple segments associated with different transmit power levels. The reception component 902 may receive, from the network node, the multi-power-level signal in accordance with the configuration. The transmission component 904 may transmit, to the network node, feedback associated with the multi-power-level signal.

The communication manager 906 may estimate an RF impairment based on the multi-power-level signal, wherein the recommended power level is based on the RF impairment.

The transmission component 904 may transmit, to the network node, UE capability information indicating at least one of a minimum segment duration for each segment of the multiple segments included in the multi-power-level signal, a minimum number of samples for each segment of the multiple segments included in the multi-power-level signal, or a minimum time offset between reception of the multi-power-level signal and transmission of the feedback.

The number and arrangement of components shown in FIG. 9 are provided as an example. In practice, there may be additional components, fewer components, different components, or differently arranged components than those shown in FIG. 9. Furthermore, two or more components shown in FIG. 9 may be implemented within a single component, or a single component shown in FIG. 9 may be implemented as multiple, distributed components. Additionally, or alternatively, a set of (one or more) components shown in FIG. 9 may perform one or more functions described as being performed by another set of components shown in FIG. 9.

FIG. 10 is a diagram of an example apparatus 1000 for wireless communication. The apparatus 1000 may be a network node, or a network node may include the apparatus 1000. In some aspects, the apparatus 1000 includes a reception component 1002, a transmission component 1004, or a communication manager 1006, which may be in communication with one another (for example, via one or more buses or one or more other components). In some aspects, the communication manager 1006 is the communication manager 155 described in connection with FIG. 1. As shown, the apparatus 1000 may communicate with another apparatus 1008, such as a UE or a network node (such as a CU, a DU, an RU, or a base station), using the reception component 1002 and the transmission component 1004. The communication manager 1006 may be included in, or implemented via, a processing system (for example, the processing system 145 described in connection with FIG. 1) of the network node.

In some aspects, the apparatus 1000 may be configured to perform one or more operations described herein in connection with FIGS. 3-4. Additionally, or alternatively, the apparatus 1000 may be configured to perform one or more processes described herein, such as process 600 of FIG. 6, process 800 of FIG. 8, or a combination thereof. In some aspects, the apparatus 1000 or one or more components shown in FIG. 10 may include one or more components of the network node described in connection with FIG. 1. Additionally, or alternatively, one or more components shown in FIG. 10 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1002 may receive communications, such as reference signals, control information, data communications, or a combination thereof, from the apparatus 1008. The reception component 1002 may provide received communications to one or more other components of the apparatus 1000. In some aspects, the reception component 1002 may perform signal processing on the received communications, and may provide the processed signals to the one or more other components of the apparatus 1000. In some aspects, the reception component 1002 may include one or more components of the network node described above in connection with FIG. 1, such as a radio, one or more RF chains, one or more transceivers, or one or more modems, each of which may in turn be coupled with one or more antennas of the network node. In some aspects, the reception component 1002 or the transmission component 1004 may include or may be included in a network interface. The network interface may be configured to obtain or output signals for the apparatus 1000 via one or more communications links, such as a backhaul link, a midhaul link, or a fronthaul link.

The transmission component 1004 may transmit communications, such as reference signals, control information, data communications, or a combination thereof, to the apparatus 1008. In some aspects, one or more other components of the apparatus 1000 may generate communications and may provide the generated communications to the transmission component 1004 for transmission to the apparatus 1008. In some aspects, the transmission component 1004 may perform signal processing on the generated communications, and may transmit the processed signals to the apparatus 1008. In some aspects, the transmission component 1004 may include one or more components of the network node described above in connection with FIG. 1, such as a radio, one or more RF chains, one or more transceivers, or one or more modems, each of which may in turn be coupled with one or more antennas of the network node described in connection with FIG. 1. In some aspects, the transmission component 1004 may be co-located with the reception component 1002.

The communication manager 1006 may support operations of the reception component 1002 or the transmission component 1004. For example, the communication manager 1006 may receive information associated with configuring reception of communications by the reception component 1002 or transmission of communications by the transmission component 1004. Additionally, or alternatively, the communication manager 1006 may generate or provide control information to the reception component 1002 or the transmission component 1004 to control reception or transmission of communications.

The transmission component 1004 may transmit, to a UE, a configuration of a multi-power-level signal including multiple segments associated with different transmit power levels. The reception component 1002 may receive, from the UE, the multi-power-level signal in accordance with the configuration.

The transmission component 1004 may transmit, to the UE, an indication of a power control parameter based at least in part on the multi-power-level signal.

The reception component 1002 may receive, from the UE, an uplink communication transmitted in accordance with the power control parameter.

The transmission component 1004 may transmit, to a UE, a configuration of a multi-power-level signal including multiple segments associated with different transmit power levels. The transmission component 1004 may transmit, to the UE, the multi- power-level signal in accordance with the configuration. The reception component 1002 may receive, from the UE, feedback associated with the multi-power-level signal.

The transmission component 1004 may transmit, to the UE, a downlink communication with a transmit power level based at least in part on the feedback.

The reception component 1002 may receive, from the UE, UE capability information indicating at least one of a minimum segment duration for each segment of the multiple segments included in the multi-power-level signal, a minimum number of samples for each segment of the multiple segments included in the multi-power-level signal, or a minimum time offset between reception of the multi-power-level signal and transmission of the feedback.

The number and arrangement of components shown in FIG. 10 are provided as an example. In practice, there may be additional components, fewer components, different components, or differently arranged components than those shown in FIG. 10. Furthermore, two or more components shown in FIG. 10 may be implemented within a single component, or a single component shown in FIG. 10 may be implemented as multiple, distributed components. Additionally, or alternatively, a set of (one or more) components shown in FIG. 10 may perform one or more functions described as being performed by another set of components shown in FIG. 10.

The following provides an overview of some Aspects of the present disclosure:

Aspect 1: A method of wireless communication performed by a user equipment (UE), comprising: receiving, from a network node, a configuration of a multi-power-level signal including multiple segments associated with different transmit power levels; and transmitting, to the network node, the multi-power-level signal in accordance with the configuration.

Aspect 2: The method of Aspect 1, wherein the multi-power-level signal is a reference signal, a control signal, a data signal, or a combination thereof.

Aspect 3: The method of any of Aspects 1-2, wherein the configuration indicates a quantity of the multiple segments.

Aspect 4: The method of any of Aspects 1-3, wherein the configuration indicates, for each segment of the multiple segments, at least one of a respective time duration for the segment, a frequency span for the segment, a beam for the segment, or a repetition factor for the segment.

Aspect 5: The method of any of Aspects 1-4, wherein the configuration indicates a start time for the multi-power-level signal, and wherein the configuration indicates, for each segment of the multiple segments, a respective offset relative to a reference segment, and a respective segment duration.

Aspect 6: The method of any of Aspects 1-5, wherein the configuration indicates a frequency domain mapping associated with the multi-power-level signal, and wherein the frequency domain mapping defines a mapping of each segment, of the multiple segments, to the frequency domain.

Aspect 7: The method of any of Aspects 1-6, wherein the configuration indicates, for each segment of the multiple segments, a respective average transmit power level over a segment duration of the segment.

Aspect 8: The method of any of Aspects 1-7, wherein the multi-power-level signal is a multi-power-level reference signal, and wherein the configuration of the multi-power-level signal is included in a channel state information resource configuration.

Aspect 9: The method of any of Aspects 1-8, wherein different segments, of the multiple segments, are associated with different transmit error vector magnitude (EVM) requirements.

Aspect 10: The method of Aspect 9, wherein the configuration indicates the different transmit EVM requirements associated with the different segments of the multiple segments.

Aspect 11: The method of any of Aspects 1-10, wherein the multi-power-level signal includes a ramp-up reference signal sequence, a ramp-down reference signal sequence, or a combination thereof.

Aspect 12: The method of any of Aspects 1-11, further comprising: receiving, from the network node, an indication of a power control parameter based at least in part on the multi-power-level signal.

Aspect 13: The method of Aspect 12, further comprising: transmitting, to the network node, an uplink communication in accordance with the power control parameter.

Aspect 14: A method of wireless communication performed by a network node, comprising: transmitting, to a user equipment (UE), a configuration of a multi-power-level signal including multiple segments associated with different transmit power levels; and receiving, from the UE, the multi-power-level signal in accordance with the configuration.

Aspect 15: The method of Aspect 14, wherein the multi-power-level signal is a reference signal, a control signal, a data signal, or a combination thereof.

Aspect 16: The method of any of Aspects 14-15, wherein the configuration indicates a quantity of the multiple segments.

Aspect 17: The method of any of Aspects 14-16, wherein the configuration indicates, for each segment of the multiple segments, at least one of a respective time duration for the segment, a frequency span for the segment, a beam for the segment, or a repetition factor for the segment.

Aspect 18: The method of any of Aspects 14-17, wherein the configuration indicates a start time for the multi-power-level signal, and wherein the configuration indicates, for each segment of the multiple segments, a respective offset relative to a reference segment, and a respective segment duration.

Aspect 19: The method of any of Aspects 14-18, wherein the configuration indicates a frequency domain mapping associated with the multi-power-level signal, and wherein the frequency domain mapping defines a mapping of each segment, of the multiple segments, to the frequency domain.

Aspect 20: The method of any of Aspects 14-19, wherein the configuration indicates, for each segment of the multiple segments, a respective average transmit power level over a segment duration of the segment.

Aspect 21: The method of any of Aspects 14-20, wherein the multi-power-level signal is a multi-power-level reference signal, and wherein the configuration of the multi-power-level signal is included in a channel state information resource configuration.

Aspect 22: The method of any of Aspects 14-21, wherein different segments, of the multiple segments, are associated with different transmit error vector magnitude (EVM) requirements.

Aspect 23: The method of Aspect 22, wherein the configuration indicates the different transmit EVM requirements associated with the different segments of the multiple segments.

Aspect 24: The method of any of Aspects 14-23, wherein the multi-power-level signal includes a ramp-up reference signal sequence, a ramp-down reference signal sequence, or a combination thereof.

Aspect 25: The method of any of Aspects 14-24, further comprising: transmitting, to the UE, an indication of a power control parameter based at least in part on the multi-power-level signal.

Aspect 26: The method of Aspect 25, further comprising: receiving, from the UE, an uplink communication transmitted in accordance with the power control parameter.

Aspect 27: A method of wireless communication performed by a user equipment (UE), comprising: receiving, from a network node, a configuration of a multi-power-level signal including multiple segments associated with different transmit power levels; receiving, from the network node, the multi-power-level signal in accordance with the configuration; and transmitting, to the network node, feedback associated with the multi-power-level signal.

Aspect 28: The method of Aspect 27, wherein the feedback includes a report indicating a respective value of at least one metric for each of one or more segments of the multiple segments.

Aspect 29: The method of Aspect 28, wherein the multi-power-level signal is a reference signal, and wherein the at least one metric includes a mean square error.

Aspect 30: The method of Aspect 29, wherein the report is a channel state information (CSI) report that includes a respective CSI sub-report indicating CSI information for each of the one or more segments.

Aspect 31: The method of any of Aspects 28-29, wherein the multi-power-level signal is a control signal or a data signal, and wherein the at least one metric includes at least one of a block error rate, a symbol error rate, or a misdetection rate.

Aspect 32: The method of Aspect 31, wherein the report is included in a channel state information report.

Aspect 33: The method of any of Aspects 28-32, wherein the report indicates a respective value of the at least one metric for each segment of the multiple segments.

Aspect 34: The method of any of Aspects 28-32, wherein the report indicates a respective value of the at least one metric for each of a selected set of segments of the multiple segments in accordance with the metric.

Aspect 35: The method of any of Aspects 28-34, wherein the multi-power-level signal includes a first set of segments, of the multiple segments, associated with a first type of signal, and a second set of segments, of the multiple segments, associated with a second type of signal, wherein the at least one metric includes a first metric associated with the first type of signal and a second metric associated with the second type of signal, and wherein the report indicates respective values of the first metric for a selected subset of the first set of segments in accordance with the first metric, and respective values of the second metric for a selected subset of the second set of segments in accordance with the second metric.

Aspect 36: The method of any of Aspects 27-35, wherein the multi-power-level signal is a control signal or a data signal, and wherein the feedback includes a respective acknowledgement or negative acknowledgement associated with decoding a control channel or a data channel for each segment of the multiple segments.

Aspect 37: The method of any of Aspects 27-36, wherein the multi-power-level signal is a control signal or a data signal, and wherein the feedback includes acknowledgements or negative acknowledgements associated with decoding respective sub-blocks of a control channel or a data channel for each segment of the multiple segments.

Aspect 38: The method of any of Aspects 27-37, wherein the feedback indicates a recommended power level.

Aspect 39: The method of Aspect 38, further comprising: estimating a radio frequency (RF) impairment based on the multi-power-level signal, wherein the recommended power level is based on the RF impairment.

Aspect 40: The method of Aspect 39, wherein estimating the RF impairment comprises: estimating the RF impairment based on respective values of a metric for the multiple segments and respective power levels for the multiple segments.

Aspect 41: The method of any of Aspects 27-40, further comprising: transmitting, to the network node, UE capability information indicating at least one of: a minimum segment duration for each segment of the multiple segments included in the multi-power-level signal, a minimum number of samples for each segment of the multiple segments included in the multi-power-level signal, or a minimum time offset between reception of the multi-power-level signal and transmission of the feedback.

Aspect 42: The method of any of Aspects 27-41, wherein the multi-power-level signal is a reference signal, a control signal, a data signal, or a combination thereof.

Aspect 43: The method of any of Aspects 27-42, wherein the configuration indicates a quantity of the multiple segments.

Aspect 44: The method of any of Aspects 27-43, wherein the configuration indicates, for each segment of the multiple segments, at least one of a respective time duration for the segment, a frequency span for the segment, a beam for the segment, or a repetition factor for the segment.

Aspect 45: The method of any of Aspects 27-44, wherein the configuration indicates a start time for the multi-power-level signal, and wherein the configuration indicates, for each segment of the multiple segments, a respective offset relative to a reference segment and a respective segment duration.

Aspect 46: The method of any of Aspects 27-45, wherein the configuration indicates a frequency domain mapping associated with the multi-power-level signal, and wherein the frequency domain mapping defines a mapping of each segment, of the multiple segments, to the frequency domain.

Aspect 47: The method of any of Aspects 27-46, wherein the configuration indicates, for each segment of the multiple segments, a respective average transmit power level over a segment duration of the segment.

Aspect 48: The method of any of Aspects 27-47, wherein the multi-power-level signal is a multi-power-level reference signal, and wherein the configuration of the multi-power-level signal is included in a channel state information resource configuration.

Aspect 49: The method of any of Aspects 27-48, wherein different segments, of the multiple segments, are associated with different transmit error vector magnitude (EVM) requirements.

Aspect 50: The method of Aspect 49, wherein the configuration indicates the different transmit EVM requirements associated with the different segments of the multiple segments.

Aspect 51: The method of any of Aspects 27-50, wherein the multi-power-level signal includes a ramp-up reference signal sequence, a ramp-down reference signal sequence, or a combination thereof.

Aspect 52: A method of wireless communication performed by a network node, comprising: transmitting, to a user equipment (UE), a configuration of a multi-power-level signal including multiple segments associated with different transmit power levels; transmitting, to the UE, the multi-power-level signal in accordance with the configuration; and receiving, from the UE, feedback associated with the multi-power-level signal.

Aspect 53: The method of Aspect 52, wherein the feedback includes a report indicating a respective value of at least one metric for each of one or more segments of the multiple segments.

Aspect 54: The method of Aspect 53, wherein the multi-power-level signal is a reference signal, and wherein the at least one metric includes a mean square error.

Aspect 55: The method of Aspect 54, wherein the report is a channel state information (CSI) report that includes a respective CSI sub-report indicating CSI information for each of the one or more segments.

Aspect 56: The method of any of Aspects 53-55, wherein the multi-power-level signal is a control signal or a data signal, and wherein the at least one metric includes at least one of a block error rate, a symbol error rate, or a misdetection rate.

Aspect 57: The method of Aspect 56, wherein the report is included in a channel state information report.

Aspect 58: The method of any of Aspects 53-57, wherein the report indicates a respective value of the at least one metric for each segment of the multiple segments.

Aspect 59: The method of any of Aspects 53-57, wherein the report indicates a respective value of the at least one metric for each of a selected set of segments of the multiple segments in accordance with the metric.

Aspect 60: The method of any of Aspects 53-59, wherein the multi-power-level signal includes a first set of segments, of the multiple segments, associated with a first type of signal, and a second set of segments, of the multiple segments, associated with a second type of signal, wherein the at least one metric includes a first metric associated with the first type of signal and a second metric associated with the second type of signal, and wherein the report indicates respective values of the first metric for a selected subset of the first set of segments in accordance with the first metric, and respective values of the second metric for a selected subset of the second set of segments in accordance with the second metric.

Aspect 61: The method of any of Aspects 52-60, wherein the multi-power-level signal is a control signal or a data signal, and wherein the feedback includes a respective acknowledgement or negative acknowledgement associated with decoding a control channel or a data channel for each segment of the multiple segments.

Aspect 62: The method of any of Aspects 52-61, wherein the multi-power-level signal is a control signal or a data signal, and wherein the feedback includes acknowledgements or negative acknowledgements associated with decoding respective sub-blocks of a control channel or a data channel for each segment of the multiple segments.

Aspect 63: The method of any of Aspects 52-62, wherein the feedback indicates a recommended power level.

Aspect 64: The method of any of Aspects 52-63, further comprising: transmitting, to the UE, a downlink communication with a transmit power level based at least in part on the feedback.

Aspect 65: The method of any of Aspects 52-64, further comprising: receiving, from the UE, UE capability information indicating at least one of: a minimum segment duration for each segment of the multiple segments included in the multi-power-level signal, a minimum number of samples for each segment of the multiple segments included in the multi-power-level signal, or a minimum time offset between reception of the multi-power-level signal and transmission of the feedback.

Aspect 66: The method of any of Aspects 52-65, wherein the multi-power-level signal is a reference signal, a control signal, a data signal, or a combination thereof.

Aspect 67: The method of any of Aspects 52-66, wherein the configuration indicates a quantity of the multiple segments.

Aspect 68: The method of any of Aspects 52-67, wherein the configuration indicates, for each segment of the multiple segments, at least one of a respective time duration for the segment, a frequency span for the segment, a beam for the segment, or a repetition factor for the segment.

Aspect 69: The method of any of Aspects 52-68, wherein the configuration indicates a start time for the multi-power-level signal, and wherein the configuration indicates, for each segment of the multiple segments, a respective offset relative to a reference segment and a respective segment duration.

Aspect 70: The method of any of Aspects 52-69, wherein the configuration indicates a frequency domain mapping associated with the multi-power-level signal, and wherein the frequency domain mapping defines a mapping of each segment, of the multiple segments, to the frequency domain.

Aspect 71: The method of any of Aspects 52-70, wherein the configuration indicates, for each segment of the multiple segments, a respective average transmit power level over a segment duration of the segment.

Aspect 72: The method of any of Aspects 52-71, wherein the multi-power-level signal is a multi-power-level reference signal, and wherein the configuration of the multi-power-level signal is included in a channel state information resource configuration.

Aspect 73: The method of any of Aspects 52-72, wherein different segments, of the multiple segments, are associated with different transmit error vector magnitude (EVM) requirements.

Aspect 74: The method of Aspect 73, wherein the configuration indicates the different transmit EVM requirements associated with the different segments of the multiple segments.

Aspect 75: The method of any of Aspects 52-74, wherein the multi-power-level signal includes a ramp-up reference signal sequence, a ramp-down reference signal sequence, or a combination thereof.

Aspect 76: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-75.

Aspect 77: An apparatus for wireless communication at a device, the apparatus comprising one or more memories and one or more processors coupled to the one or more memories, the one or more processors configured to cause the device to perform the method of one or more of Aspects 1-75.

Aspect 78: An apparatus for wireless communication, the apparatus comprising at least one means for performing the method of one or more of Aspects 1-75.

Aspect 79: A non-transitory computer-readable medium storing code for wireless communication, the code comprising instructions executable by one or more processors to perform the method of one or more of Aspects 1-75.

Aspect 80: A non-transitory computer-readable medium storing a set of instructions for wireless communication, the set of instructions comprising one or more instructions that, when executed by one or more processors of a device, cause the device to perform the method of one or more of Aspects 1-75.

Aspect 81: A device for wireless communication, the device comprising a processing system that includes one or more processors and one or more memories coupled with the one or more processors, the processing system configured to cause the device to perform the method of one or more of Aspects 1-75.

Aspect 82: An apparatus for wireless communication at a device, the apparatus comprising one or more memories and one or more processors coupled to the one or more memories, the one or more processors individually or collectively configured to cause the device to perform the method of one or more of Aspects 1-75.

Aspect 83: A device comprising a processing system that includes one or more processors and one or more code-storing memories coupled with the one or more processors, the processing system configured to cause the device to perform the method of one or more of Aspects 1-75.

Aspect 84: A device comprising a processing system that includes processor circuitry and code-storing memory circuitry, the processing system configured to cause the device to perform the method of one or more of Aspects 1-75.

It will be apparent that systems or methods described herein may be implemented in different forms of hardware or a combination of hardware and software. A component being configured to perform a function means that the component has a capability to perform the function, and does not require the function to be actually performed by the component, unless noted otherwise.

As used herein, the term “determine” or “determining” can encompass one or more of a wide variety of actions. For example, “determining” can include one or more of calculating, computing, processing, deriving, detecting, estimating, investigating, looking up, inferring, ascertaining, measuring, resolving, selecting, choosing, obtaining, identifying, interpreting, demodulating, decoding, reading, establishing, forming or generating, among other examples. In some such examples, determining can involve a processor performing some type of calculating, computing, deriving, estimating, inferring, ascertaining, resolving, predicting or other processing to obtain one or more numerical values, sets, elements or other information or results. In some other such examples, determining can involve a processor identifying, looking up, investigating or otherwise obtaining some type of value, set, element or other information or result from a table, a data structure, a database or other memory device or location. In some other such examples, determining can involve a processor identifying, interpreting, demodulating, decoding, detecting, reading or otherwise obtaining some type of value, set, element or other information or result signaled in, for example, a received wireless packet. In some other such examples, determining can involve a processor selecting or choosing one or more values, sets, elements or other information or results from a larger set of values, sets elements or other information or results. In some other such examples, determining can involve a processor performing a measurement, such as on a received signal.

As used herein, the articles “a” and “an” are intended to refer to one or more items and may be used interchangeably with “one or more” or “at least one.” As used herein, a phrase referring to “at least one of” or “one or more of” a list of items refers to any combination of those items, including single members. As an example, “at least one of: a, b, or c” is intended to cover: a, b, c, a-b, a-c, b-c, and a-b-c. Additionally, as used herein, a phrase referring to “a” or “an” element refers to one or more of such elements acting individually or collectively to perform the recited function(s). Additionally, as used herein, a “set” can refer to one or more items, and a “subset” can refer to a whole set or less than the whole set, but not an empty set. “Set,” “group,” and similar terms are intended to include one or more items and may be used interchangeably with “one or more.” Furthermore, as used herein, the term “or” is intended to be interpreted in the inclusive sense (such as when referring to a series) and may be used interchangeably with “and/or,” unless otherwise explicitly indicated (for example, if used in conjunction with “either” or “only one of”). For example, “A or B” may include A only, B only, or a combination of A and B. Also, as used herein, the terms “has,” “have,” “having,” “comprise,” “comprising,” “include” and “including,” and derivatives thereof or similar terms are intended to be open-ended terms that do not limit an element that they modify (for example, an element “having” A also may have B).

As used herein, the phrase “associated with” is intended to be interpreted in the inclusive sense, unless otherwise explicitly indicated. For example, the phrase “associated with” is not to be construed as a reference to a closed set of conditions, factors, criteria, elements, components, or actions, among other examples. Specifically, unless a phrase refers to “associated with only ‘a,’” or the equivalent in context, whatever it is that is “associated with ‘a,’” may be associated with “a” alone or associated with a combination of “a” and one or more other conditions, factors, criteria, elements, components, or actions, among other examples. In various examples, the phrase “associated with” may be interpreted to mean “in association with,” “in accordance with,” “based on,” “based at least in part on,” “as a function of,” “in response to,” “responsive to,” or “using” as appropriate in the relevant context unless otherwise explicitly indicated. Furthermore, what follows the phrase “associated with,” “in association with,” “in accordance with,” “based on,” “based at least in part on,” “as a function of,” “in response to,” “responsive to,” or “using” is not necessarily the focal point or primary factor associated with the limitation preceding the phrase.

As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

Even though particular combinations of features are recited in the claims or disclosed in the specification, these combinations are not intended to limit the scope of all aspects described herein. Many of these features may be combined in ways not specifically recited in the claims or disclosed in the specification. The disclosure of various aspects includes each dependent claim in combination with every other claim in the claim set.

What is claimed is:

1. A user equipment (UE), comprising:
a processing system that includes one or more processors and one or more code-storing memories coupled with the one or more processors, the processing system configured to cause the UE to:
receive, from a network node, a configuration of a multi-power-level signal including multiple segments associated with different transmit power levels;
receive, from the network node, the multi-power-level signal in accordance with the configuration; and
transmit, to the network node, feedback associated with the multi-power-level signal.

2. The UE of claim 1, wherein the feedback includes a report indicating a respective value of at least one metric for each of one or more segments of the multiple segments.

3. The UE of claim 2, wherein the multi-power-level signal is a reference signal, and wherein the at least one metric includes a mean square error.

4. The UE of claim 2, wherein the multi-power-level signal is a control signal or a data signal, and wherein the at least one metric includes at least one of a block error rate, a symbol error rate, or a misdetection rate.

5. The UE of claim 2, wherein the report indicates a respective value of the at least one metric for each segment of the multiple segments, or
wherein the report indicates a respective value of the at least one metric for each of a selected set of segments of the multiple segments in accordance with the metric.

6. The UE of claim 1, wherein the multi-power-level signal is a control signal or a data signal, and wherein the feedback includes a respective acknowledgement or negative acknowledgement associated with decoding a control channel or a data channel for each segment of the multiple segments.

7. The UE of claim 1, wherein the feedback indicates a recommended power level, and wherein the processing system is configured to cause the UE to:
estimate a radio frequency (RF) impairment based on the multi-power-level signal, wherein the recommended power level is based on the RF impairment.

8. The UE of claim 1, wherein the processing system is configured to cause the UE to:
transmit, to the network node, UE capability information indicating at least one of:
a minimum segment duration for each segment of the multiple segments included in the multi-power-level signal,
a minimum number of samples for each segment of the multiple segments included in the multi-power-level signal, or
a minimum time offset between reception of the multi-power-level signal and transmission of the feedback.

9. The UE of claim 1, wherein the configuration indicates a quantity of the multiple segments, and wherein the configuration indicates, for each segment of the multiple segments, at least one of a respective time duration for the segment, a frequency span for the segment, a beam for the segment, a repetition factor for the segment, or a respective average transmit power level over a segment duration of the segment.

10. The UE of claim 1, wherein different segments, of the multiple segments, are associated with different transmit error vector magnitude (EVM) requirements.

11. The UE of claim 1, wherein the multi-power-level signal includes a ramp-up reference signal sequence, a ramp-down reference signal sequence, or a combination thereof.

12. A network node, comprising:
a processing system that includes one or more processors and one or more code-storing memories coupled with the one or more processors, the processing system configured to cause the network node to:
transmit, to a user equipment (UE), a configuration of a multi-power-level signal including multiple segments associated with different transmit power levels;
transmit, to the UE, the multi-power-level signal in accordance with the configuration; and
receive, from the UE, feedback associated with the multi-power-level signal.

13. A user equipment (UE), comprising:
a processing system that includes one or more processors and one or more code-storing memories coupled with the one or more processors, the processing system configured to cause the UE to:
receive, from a network node, a configuration of a multi-power-level signal including multiple segments associated with different transmit power levels; and
transmit, to the network node, the multi-power-level signal in accordance with the configuration.

14. The UE of claim 13, wherein the multi-power-level signal is a reference signal, a control signal, a data signal, or a combination thereof.

15. The UE of claim 13, wherein the configuration indicates a quantity of the multiple segments, and wherein the configuration indicates, for each segment of the multiple segments, at least one of a respective time duration for the segment, a frequency span for the segment, a beam for the segment, a repetition factor for the segment, or a respective average transmit power level over a segment duration of the segment.

16. The UE of claim 13, wherein the configuration indicates a start time for the multi-power-level signal, and wherein the configuration indicates, for each segment of the multiple segments, a respective offset relative to a reference segment, and a respective segment duration.

17. The UE of claim 13, wherein the configuration indicates a frequency domain mapping associated with the multi-power-level signal, and wherein the frequency domain mapping defines a mapping of each segment, of the multiple segments, to the frequency domain.

18. The UE of claim 13, wherein the multi-power-level signal is a multi-power-level reference signal, and wherein the configuration of the multi-power-level signal is included in a channel state information resource configuration.

19. The UE of claim 13, wherein different segments, of the multiple segments, are associated with different transmit error vector magnitude (EVM) requirements.

20. The UE of claim 13, wherein the processing system is configured to cause the UE to:
receive, from the network node, an indication of a power control parameter based at least in part on the multi-power-level signal; and
transmit, to the network node, an uplink communication in accordance with the power control parameter.
